(19) United States
(12) Patent Application Publication
(10) Pub. No.: US 2019/0235410 A1
(43) Pub. Date: Aug. 1, 2019

(54) IMAGE FORMING APPARATUS

(71) Applicant: Oki Data Corporation, Tokyo (JP)

(72) Inventor: Hiroyuki NAKAZAWA, Tokyo (JP)

(73) Assignee: Oki Data Corporation, Tokyo (JP)

(21) Appl. No.: 16/253,204

(22) Filed: Jan. 21, 2019

(30) Foreign Application Priority Data
Jan. 29, 2018 (JP) 2018-012614

(51) Int. Cl. G03G 15/06; G03G 15/08; G03G 15/01

(52) U.S. Cl. CPC G03G 15/065; G03G 15/0121; G03G 15/0849

(57) ABSTRACT

An image forming apparatus includes one or more developing units, a detector, a voltage application unit, one or more exposure units, an image conveying member, one or more primary transfer members, a sensor, and a setting unit. The one or more developing units each include a photosensitive member and a developing member. The detector detects the one or more developing units. The voltage application unit applies a development voltage to the developing member. The one or more exposure units each expose the photosensitive member. The one or more primary transfer members each transfer, onto the image conveying member, a developer image. The sensor detects a developer amount on the image conveying member. The setting unit acquires developing unit information on a detection result from the detector, and sets a first-developing-unit development voltage, first-developing-unit exposure energy, or both on a detection result from the sensor and the developing unit information.

### CROSS REFERENCE TO RELATED APPLICATIONS

The present application claims priority from Japanese Patent Application No. 2018-012614 filed on Jan. 29, 2018, the entire contents of which are hereby incorporated by reference.

### BACKGROUND

The technology relates to an image forming apparatus that forms an image.

An image forming apparatus may form, for example, a developer image or a toner patch on a transfer belt. Further, the image forming apparatus may adjust, on the basis of a density of a developer of the developer image formed on the transfer belt, an image forming condition on which an image is to be formed on a print medium. This technique is disclosed, for example, in Japanese Unexamined Patent Application Publication No. 2008-233369.

### SUMMARY

It is desired to set, to an appropriate density, a density of a developer to be provided on a print medium in an image forming apparatus.

It is desirable to provide an image forming apparatus that is able to set, to an appropriate density, a density of a developer to be provided on a print medium. According to one embodiment of the technology, there is provided an image forming apparatus that includes one or more developing units, a detector, a voltage application unit, one or more exposure units, an image conveying member, one or more primary transfer members, a sensor, and a setting unit. The one or more developing units include a first developing unit and are each operably set to corresponding one of a plurality of stations. The one or more developing units each include a photosensitive member and a developing member. The developing member forms a developer image by developing, with a developer, an electrostatic latent image formed on the photosensitive member. The detector performs a detection of the one or more developing units. The voltage application unit applies a development voltage to the developing member of each of the one or more developing units. The one or more exposure units each perform exposure of the photosensitive member of corresponding one of the one or more developing units. The image conveying member conveys the developer image along a path that passes through the plurality of stations. The one or more primary transfer members each transfer, onto the image conveying member, the developer image formed on the photosensitive member of corresponding one of the one or more developing units. The sensor performs a detection of an amount of the developer present on the image conveying member. The setting unit acquires developing unit information on the basis of a result of the detection performed by the detector, and sets a first-developing-unit development voltage, first-developing-unit exposure energy, or both on the basis of a result of the detection performed by the sensor and information. The information is included in the developing unit information and related to one or more downstream stations. The developing unit information is information related to the one or more developing units each operably set to the corresponding one of the plurality of stations. The one or more downstream stations are one or more, of the plurality of stations, positioned downstream, in a direction of conveyance performed by the image conveying member, of one of the plurality of stations to which the first developing unit is set. The first-developing-unit development voltage is the development voltage to be applied to the developing member of the first developing unit. The first-developing-unit exposure energy is exposure energy in one, of the one or more exposure units, which corresponds to the first developing unit.

### BRIEF DESCRIPTION OF DRAWINGS

FIG. 1 is a configuration diagram illustrating an example of a configuration of an image forming apparatus according to one embodiment of the technology.

FIG. 2 is a configuration diagram illustrating an example of a configuration of a developing unit illustrated in FIG. 1.

FIG. 3 is a configuration diagram illustrating an example of a configuration of a density sensor illustrated in FIG. 1.

FIG. 4A is an explanatory diagram illustrating an example of operation of a density sensor illustrated in FIG. 3.

FIG. 4B is another explanatory diagram illustrating an example of the operation of the density sensor illustrated in FIG. 3.

FIG. 5 is a block diagram illustrating an example of a control mechanism of an image forming apparatus according to one embodiment of the technology.

FIG. 6A is a table illustrating an example of a conversion table illustrated in FIG. 5.

FIG. 6B is a table illustrating another example of the conversion table illustrated in FIG. 5.

FIG. 7 is a table illustrating an example of a target density table illustrated in FIG. 5.

FIG. 8 is a table illustrating an example of a development voltage correction table illustrated in FIG. 5.

FIG. 9 is a table illustrating an example of an exposure time correction table illustrated in FIG. 5.

FIG. 10 is a flowchart illustrating an example of operation of the image forming apparatus according to one embodiment.

FIG. 11 is a table illustrating an example of a developing unit information table illustrated in FIG. 10.

FIG. 12 is a table illustrating another example of the developing unit information table illustrated in FIG. 10.

FIG. 13 is a flowchart illustrating an example of a density correction process according to one embodiment.

FIG. 14 is an explanatory diagram illustrating an example of a density detection pattern according to one embodiment.

FIG. 15A is an explanatory diagram illustrating an example of a dither pattern according to one embodiment.

FIG. 15B is an explanatory diagram illustrating another example of the dither pattern according to one embodiment.

FIG. 15C is an explanatory diagram illustrating still another example of the dither pattern according to one embodiment.

FIG. 16 is an explanatory diagram illustrating another example of the density detection pattern according to one embodiment.

FIG. 17A is an explanatory diagram illustrating an example of a result of an experiment.

FIG. 17B is an explanatory diagram illustrating another example of a result of an experiment.

FIG. 18 is an explanatory diagram illustrating still another example of a result of an experiment.

FIG. 19A is a table illustrating an example of a conversion table according to a modification example of one embodiment.

FIG. 19B is a table illustrating another example of the conversion table according to the modification example of one embodiment.

FIG. 20 is a table illustrating an example of a development voltage correction table according to a modification example of one embodiment.

FIG. 21 is a table illustrating an example of an exposure time correction table according to the modification example of one embodiment.

FIG. 22 is a block diagram illustrating an example of a control mechanism of an image forming apparatus according to one embodiment.

FIG. 23 is a flowchart illustrating an example of operation of the image forming apparatus according to one embodiment.

FIG. 24 is an explanatory diagram schematically illustrating an example of the operation of the image forming apparatus according to one embodiment.

### DETAILED DESCRIPTION

Hereinafter, some example embodiments of the technology will be described in detail with reference to the drawings. Note that the following description is directed to illustrative examples of the technology and not to be construed as limiting to the technology. Factors including, without limitation, numerical values, shapes, materials, components, positions of the components, and how the components are coupled to each other are illustrative only and not to be construed as limiting to the technology. Further, elements in the following example embodiments which are not recited in a most-generic independent claim of the technology are optional and may be provided on an as-needed basis. The drawings are schematic and are not intended to be drawn to scale. Note that the like elements are denoted with the same reference numerals, and any redundant description thereof will not be described in detail. The description will be given in the following order.

1. First Example Embodiment (An example in which a correction is made on the basis of number of developing units set downstream of a developing unit of interest)
2. Second Example Embodiment (An example in which a correction is made on the basis of a color of a developing unit set downstream of a developing unit of interest)

### 1. FIRST EXAMPLE EMBODIMENT

### Configuration Example

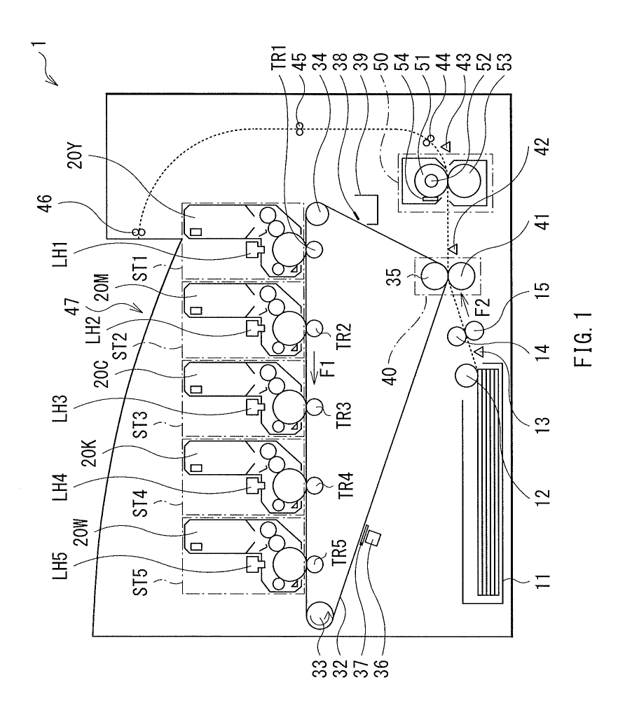

FIG. 1 illustrates an example of a configuration of an image forming apparatus 1, i.e., an image forming apparatus according to a first example embodiment of the technology. The image forming apparatus 1 may serve as a printer that forms an image on a print medium by an electrophotographic method, for example. Non-limiting examples of the print medium may include plain paper and any other material on which an image can be formed.

The image forming apparatus 1 may include five developing units 20, five light-emitting diode (LED) heads LH, five primary transfer rollers TR, an intermediate transfer belt 32, a driving roller 33, a driven roller 34, a secondary transfer opposed roller 35, a density sensor 36, a sensor cover 37, a cleaning blade 38, and a waste toner container 39. The five developing units 20 may be developing units 20Y, 20M, 20C, 20K, and 20W, for example. The five LED heads LH may be LED heads LH1, LH2, LH3, LH4, and LH5, for example. The five primary transfer rollers TR may be primary transfer rollers TR1, TR2, TR3, TR4, and TR5, for example.

The five developing units 20 may each form a toner image. For example, the developing unit 20Y may form a toner image of yellow (Y). The developing unit 20M may form a toner image of magenta (M). The developing unit 20C may form a toner image of cyan (C). The developing unit 20K may form a toner image of black (K). The developing unit 20W may form a toner image of white (W).

The image forming apparatus 1 may include five stations ST to which the respective developing units 20 are settable. The five stations ST may be stations ST1, ST2, ST3, ST4, and ST5, for example. In this example, the five stations ST1, ST2, ST3, ST4, and ST5 may be disposed in this order in a conveyance direction F1. The conveyance direction F1 may be a direction in which the intermediate transfer belt 32 is to be conveyed. Further, in this example, the developing unit 20Y may be set to the station ST1. The developing unit 20M may be set to the station ST2. The developing unit 20C may be set to the station ST3. The developing unit 20K may be set to the station ST4. The developing unit 20W may be set to the station ST5. Each of the developing units 20 may be attachable to and detachable from any of the five stations ST1 to ST5. Accordingly, in one example, the image forming apparatus 1 may allow for a change in the order of the developing units 20 set in the respective five stations ST1 to ST5 and perform image forming operation. The order of the developing units 20 set to the respective five stations ST1 to ST5 may be, for example, the order of the colors of the respective developing units 20. In another example, the image forming apparatus 1 may allow for a change in the number of the developing units 20 set to the five stations ST1 to ST5 and perform the image forming operation.

Further, the image forming apparatus 1 may have a configuration in which each of the five developing units 20 is allowed to be separated away from the intermediate transfer belt 32, for example, on the basis of user operation. For example, a user may open an unillustrated apparatus cover of the image forming apparatus 1 and so put down the to-be-used developing unit 20 that the to-be-used developing unit 20 to be closer to the intermediate transfer belt 32. The user may thereby allow the to-be-used developing unit 20 to be in an operable state. For example, the user may so lift the non-use developing unit 20 that the non-use developing unit 20 to be away from the intermediate transfer belt 32. The user may thereby allow the non-use developing unit 20 to be in a non-operable state. Accordingly, the image forming apparatus 1 suppresses deterioration due to use as a result of, for example, causing the non-use developing unit 20 to be in the non-operable state. Further, the image forming apparatus 1 suppresses a toner consumption amount as a result of, for example, allowing the non-use developing unit 20 to be in the non-operable state. As used herein, a state in which the developing unit 20 is so pressed down that the developing unit 20 is closer to the intermediate transfer belt 32 may be referred to as a “down state DN”. A state in which the developing unit 20 is so lift that the developing unit 20 is away from the intermediate transfer belt 32 may also be referred to as an “up state UP”. In other words, the down state DN may be the state in which the developing unit 20 is operable, and the up state UP may be the state in which the developing unit 20 is non-operable.

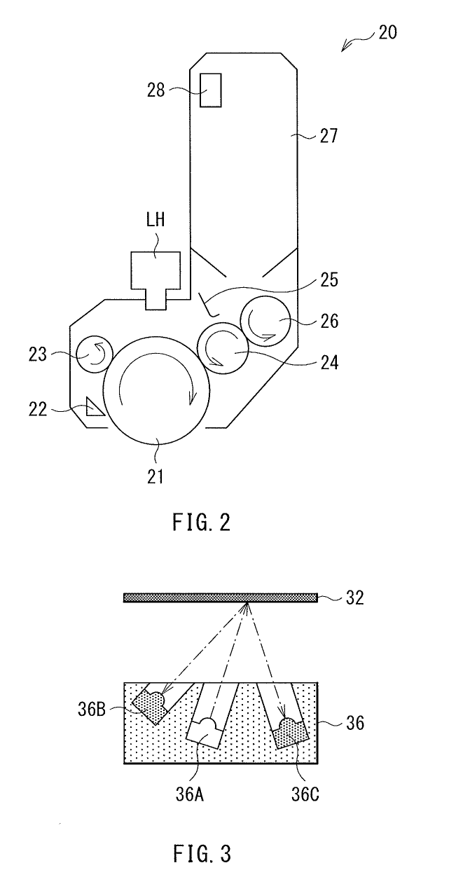

FIG. 2 illustrates an example of a configuration of the developing unit 20. FIG. 2 also illustrates the LED head LH. The developing unit 20 may include a photosensitive drum 21, a light source 22, a charging roller 23, a developing roller 24, a developing blade 25, a feeding roller 26, a toner container 27, and an integrated circuit (IC) tag 28.

The photosensitive drum 21 may have a surface (a surficial part) that supports an electrostatic latent image. The photosensitive drum 21 may be rotated by power transmitted from a drum motor 85 which will be described later. In this example, the photosensitive drum 21 may be rotated clockwise. The photosensitive drum 21 may be electrically charged by the charging roller 23, and be subjected to exposure by the LED head LH. For example, the photosensitive drum 21 of the developing unit 20 set to the station ST1, i.e., the developing unit 20Y in this example, may be subjected to exposure by the LED head LH1. The photosensitive drum 21 of the developing unit 20 set to the station ST2, i.e., the developing unit 20M in this example, may be subjected to exposure by the LED head LH2. The photosensitive drum 21 of the developing unit 20 set to the station ST3, i.e., the developing unit 20C in this example, may be subjected to exposure by the LED head LH3. The photosensitive drum 21 of the developing unit 20 set to the station ST4, i.e., the developing unit 20K in this example, may be subjected to exposure by the LED head LH4. The photosensitive drum 21 of the developing unit 20 set to the station ST5, i.e., the developing unit 20W in this example, may be subjected to exposure by the LED head LH5. The electrostatic latent image may be thereby formed on the surface of each of the photosensitive drums 21. Further, the toner may be fed to the photosensitive drum 21 by the developing roller 24. A toner image based on the electrostatic latent image may be thereby formed on the photosensitive drum 21. In other words, the toner image based on the electrostatic latent image may be thereby developed on the photosensitive drum 21.

The light source 22 may output destaticizing light toward the photosensitive drum 21. The destaticizing light may reset an electric charge state of the surface (the surficial part) of the photosensitive drum 21.

The charging roller 23 may electrically charge the surface (the surficial part) of the photosensitive drum 21. The charging roller 23 may be disposed in contact with a surface (a circumferential surface) of the photosensitive drum 21, and pressed against the photosensitive drum 21 with a predetermined pressing amount. The charging roller 23 may be rotated in accordance with the rotation of the photosensitive drum 21. In this example, the charging roller 23 may be rotated counterclockwise. The charging roller 23 may receive a charging voltage from a charging voltage generator 72 which will be described later.

The developing roller 24 may have a surface that supports the toner. The developing roller 24 may feed the foregoing toner to the photosensitive drum 21 by means of electrostatic force, and thereby develop the electrostatic latent image formed on the photosensitive drum 21. The developing roller 24 may be disposed in contact with the surface (the circumferential surface) of the photosensitive drum 21, and pressed against the photosensitive drum 21 by a predetermined pressing amount. The developing roller 24 may be rotated by power transmitted from the drum motor 85 which will be described later. In this example, the developing roller 24 may be rotated counterclockwise. The developing roller 24 may receive a development voltage from a development voltage generator 74 which will be described later.

The developing blade 25 may be in contact with the surface of the developing roller 24. Thereby, the developing blade 25 may allow a layer of toner (a toner layer) to be formed on the surface of the developing roller 24 while controlling or adjusting a thickness of the formed toner layer. The developing blade 25 may be, for example, a plate-shaped elastic member bent in an L-like shape. The foregoing plate-shaped elastic member may include a material such as stainless steel. The developing blade 25 may be disposed with its bent portion being in contact with the surface of the developing roller 24. The developing blade 25 may be so disposed as to be pressed against the developing roller 24 with a predetermined pressing amount.

The feeding roller 26 may feed, to the developing roller 24, the toner contained in the toner container 27. The feeding roller 26 may be disposed in contact with a surface (a circumferential surface) of the developing roller 24, and pressed against the developing roller 24 with a predetermined pressing amount. The feeding roller 26 may be rotated by power transmitted from the drum motor 85 which will be described later. In this example, the feeding roller 26 may be rotated counterclockwise. This may generate friction between the surface of the feeding roller 26 and the surface of the developing roller 24 in each of the developing units 20. As a result, the toner may be electrically charged by so-called frictional electrification in each of the developing units 20. The feeding roller 26 may receive a feeding voltage from a feeding voltage generator 73 which will be described later.

The toner container 27 may contain the toner to be used in development. For example, the toner container 27 of the developing unit 20Y may contain the toner of yellow (Y). The toner container 27 of the developing unit 20M may contain the toner of magenta (M). The toner container 27 of the developing unit 20C may contain the toner of cyan (C). The toner container 27 of the developing unit 20K may contain the toner of black (K). The toner container 27 of the developing unit 20W may contain the toner of white (W).

The IC tag 28 may hold information related to, for example but not limited to, an identification number of the developing unit 20 or the color of the toner in the toner container 27. The information held by the IC tag 28 may be read, for example, via a developing unit detector 66 which will be described later by means of communication such as wired communication or wireless communication.

The five LED heads LH may each perform exposure of the photosensitive drum 21 of the developing unit 20 set to corresponding one of the five stations ST. For example, the LED head LH1 may perform exposure of the photosensitive drum 21 of the developing unit 20 set to the station ST1, i.e., the developing unit 20Y in this example. The LED head LH2 may perform exposure of the photosensitive drum 21 of the developing unit 20 set to the station ST2, i.e., the developing unit 20M in this example. The LED head LH3 may perform exposure of the photosensitive drum 21 of the developing unit 20 set to the station ST3, i.e., the developing unit 20C in this example. The LED head LH4 may perform exposure of the photosensitive drum 21 of the developing unit 20 set to the station ST4, i.e., the developing unit 20K in this example. The LED head LH5 may perform exposure of the photosensitive drum 21 of the developing unit 20 set to the station ST5, i.e., the developing unit 20W in this example. Each of the LED heads LH may include an LED array, a drive circuit, and a lens array, for example. The LED array may include a plurality of light-emitting diodes arranged side by side in a direction of a main scanning line, i.e., a depth direction in FIG. 1. The drive circuit may drive the LED array. The lens array may condense light outputted from the LED array. The drive circuit may receive an image signal from an exposure controller 63 which will be described later. For example, the drive circuit of the LED head LH1 may receive an image signal corresponding to the color of the toner of the developing unit 20 set to the station ST1. In this example, the drive circuit of the LED head LH1 may receive an image signal corresponding to the color of yellow of the toner of the developing unit 20Y. The drive circuit of the LED head LH2 may receive an image signal corresponding to the color of the toner of the developing unit 20 set to the station ST2. In this example, the drive circuit of the LED head LH2 may receive an image signal corresponding to the color of magenta of the toner of the developing unit 20M. The drive circuit of the LED head LH3 may receive an image signal corresponding to the color of the toner of the developing unit 20 set to the station ST3. In this example, the drive circuit of the LED head LH3 may receive an image signal corresponding to the color of cyan of the toner of the developing unit 20C. The drive circuit of the LED head LH4 may receive an image signal corresponding to the color of the toner of the developing unit 20 set to the station ST4. In this example, the drive circuit of the LED head LH4 may receive an image signal corresponding to the color of black of the toner of the developing unit 20K. The drive circuit of the LED head LH5 may receive an image signal corresponding to the color of the toner of the developing unit 20 set to the station ST5. In this example, the drive circuit of the LED head LH5 may receive an image signal corresponding to the color of white of the toner of the developing unit 20W. Further, each of the LED heads LH may perform exposure of the photosensitive drum 21 on a dot-unit basis on the basis of the received image signal. The photosensitive drum 21 may be thereby subjected to the exposure, allowing the electrostatic latent image to be formed on the surface of the photosensitive drum 21.

The five primary transfer rollers TR may each electrostatically transfer, onto a transfer surface of the intermediate transfer belt 32, the toner image formed by corresponding one of the five developing units 20. The primary transfer roller TR1 may face the photosensitive drum 21 of the developing unit 20 set to the station ST1, i.e., the developing unit 20Y in this example, with the intermediate transfer belt 32 in between. The primary transfer roller TR1 may be pressed against the foregoing photosensitive drum 21 with a predetermined pressing amount. The primary transfer roller TR2 may face the photosensitive drum 21 of the developing unit 20 set to the station ST2, i.e., the developing unit 20M in this example, with the intermediate transfer belt 32 in between. The primary transfer roller TR2 may be pressed against the foregoing photosensitive drum 21 with a predetermined pressing amount. The primary transfer roller TR3 may face the photosensitive drum 21 of the developing unit 20 set to the station ST3, i.e., the developing unit 20C in this example, with the intermediate transfer belt 32 in between. The primary transfer roller TR3 may be pressed against the foregoing photosensitive drum 21 with a predetermined pressing amount. The primary transfer roller TR4 may face the photosensitive drum 21 of the developing unit 20 set to the station ST4, i.e., the developing unit 20K in this example, with the intermediate transfer belt 32 in between. The primary transfer roller TR4 may be pressed against the foregoing photosensitive drum 21 with a predetermined pressing amount. The primary transfer roller TR5 may face the photosensitive drum 21 of the developing unit 20 set to the station ST5, i.e., the developing unit 20W in this example, with the intermediate transfer belt 32 in between. The primary transfer roller TR5 may be pressed against the foregoing photosensitive drum 21 with a predetermined pressing amount. Each of the primary transfer rollers TR may receive a primary transfer voltage by a primary transfer voltage generator 75 which will be described later. Thereby, the toner image formed by each of the developing units 20 may be transferred onto the transfer surface of the intermediate transfer belt 32 in the image forming apparatus 1. In other words, primary transfer may be thereby performed in the image forming apparatus 1.

The intermediate transfer belt 32 may be an elastic endless belt that supports the toner images formed by the five developing units 20 in this example. The intermediate transfer belt 32 may lie on the driving roller 33, the driven roller 34, and the secondary transfer opposed roller 35 while being stretched. In this example, the transfer surface of the intermediate transfer belt 32 may be glossy and have high specular reflectivity. In one example, the specular reflectivity of the intermediate transfer belt 32 may be uniform over the transfer surface of the intermediate transfer belt 32. The intermediate transfer belt 32 may be circularly conveyed in a direction of the conveyance direction F1 in accordance with rotation of the driving roller 33. When being thus conveyed circularly, the intermediate transfer belt 32 may be conveyed along a path that passes: between the primary transfer roller TR1 and the photosensitive drum 21 of the developing unit 20 set to the station ST1, i.e., the developing unit 20Y in this example; between the primary transfer roller TR2 and the photosensitive drum 21 of the developing unit 20 set to the station ST2, i.e., the developing unit 20M in this example; between the primary transfer roller TR3 and the photosensitive drum 21 of the developing unit 20 set to the station ST3, i.e., the developing unit 20C in this example; between the primary transfer roller TR4 and the photosensitive drum 21 of the developing unit 20 set to the station ST4, i.e., the developing unit 20K in this example; and between the primary transfer roller TR5 and the photosensitive drum 21 of the developing unit 20 set to the station ST5, i.e., the developing unit 20W in this example.

The driving roller 33 may circularly convey the intermediate transfer belt 32. In this example, the driving roller 33 may be disposed downstream of the five developing units 20 in the conveyance direction F1. In this example, the driving roller 33 may rotate counterclockwise by power transmitted from a belt motor 83 which will be described later. The driving roller 33 may thereby circularly convey the intermediate transfer belt 32 in a direction of the conveyance direction F1.

The driven roller 34 may be rotated in accordance with the circular conveyance of the intermediate transfer belt 32. The driven roller 34 may be disposed upstream of the five developing units 20 in the conveyance direction F1.

The secondary transfer opposed roller 35 may be rotated in accordance with the circular conveyance of the intermediate transfer belt 32. The secondary transfer opposed roller 35 may include, for example, a metal shaft and a metal roller. The secondary transfer opposed roller 35 may face a secondary transfer roller 41 with a conveyance path 8 and the intermediate transfer belt 32 in between. The conveyance path 8 may be a path along which the print medium 9 is to be conveyed. The secondary transfer opposed roller 35 and the secondary transfer roller 41 may be included together in a secondary transfer section 40. The secondary transfer opposed roller 35 may receive a predetermined voltage from a secondary transfer voltage generator 76 which will be described later.

The density sensor 36 may output a detected value V in a density correction process which will be described later. The detected value V may be a value based on a toner density of the toner image of each color included in a density detection pattern PAT formed on the transfer surface of the intermediate transfer belt 32. The density detection pattern PAT will be described later.

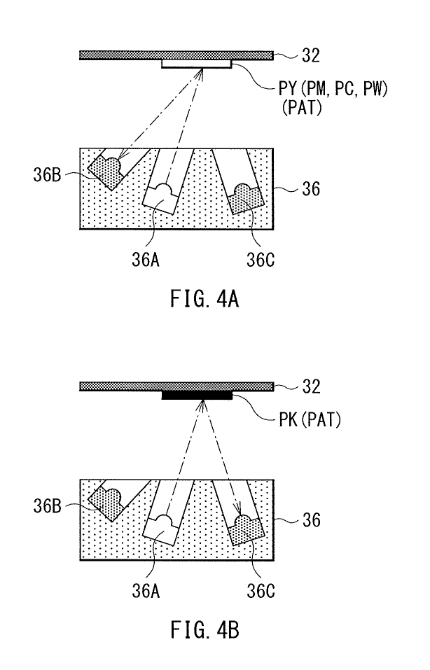

FIG. 3 illustrates an example of a configuration of the density sensor 36. FIGS. 4A and 4B each illustrate an example of operation of the density sensor 36. FIGS. 3, 4A, and 4B also illustrate the intermediate transfer belt 32. The density sensor 36 may include a light-emitting diode 36A, a phototransistor 36B, and a phototransistor 36C.

The light-emitting diode 36A may output infrared light toward the transfer surface of the intermediate transfer belt 32.

The phototransistor 36B may receive infrared light diffusely reflected by the toner on the intermediate transfer belt 32. Further, the phototransistor 36B may output the detected value V based on an amount of the received infrared light. The phototransistor 36B may be used upon detection of a toner density of each of a yellow toner image PY, a magenta toner image PM, a cyan toner image PC, and a white toner image PW all included in the density detection pattern PAT formed on the intermediate transfer belt 32. The density detection pattern PAT will be described later. For example, as illustrated in FIG. 4A, the phototransistor 36B may receive infrared light diffusely reflected by the toner of the yellow toner image PY. When the toner density of the yellow toner image PY is higher, the amount of the infrared light diffusely reflected may be greater. Accordingly, the detected value V outputted by the phototransistor 36B may be higher. This may be similarly applicable to each of the colors of magenta, cyan, and white.

The phototransistor 36C may receive infrared light specularly reflected by the intermediate transfer belt 32. Further, the phototransistor 36C may output the detected value V based on an amount of the received infrared light. The phototransistor 36C may be used upon detection of a toner density of the black toner image PK included in the density detection pattern PAT formed on the intermediate transfer belt 32. The density detection pattern PAT will be described later. As illustrated in FIG. 4B, the phototransistor 36C may receive infrared light specularly reflected by the intermediate transfer belt 32 in a portion, of the black toner image PK, with no toner attached. When the toner density of the black toner image PK is higher, the amount of the infrared light specularly reflected may be smaller. Accordingly, the detected value V outputted by the phototransistor 36C may be lower.

The sensor cover 37 may cover a detection surface of the density sensor 36. The sensor cover 37 may thus prevent a substance such as the toner or paper dust from being attached to the density sensor 36, and thereby protect the density sensor 36. The sensor cover 37 may be movable by an unillustrated drive mechanism. When the image forming apparatus 1 is to perform the density correction process, the sensor cover 37 may move to a position away from the detection surface of the density sensor 36. The sensor cover 37 may thereby allow the density sensor 36 to detect the toner density of the toner image on the intermediate transfer belt 32. When the image forming apparatus 1 is not to perform the density correction process, the sensor cover 37 may move to a position at which the sensor cover 37 covers the detection surface of the density sensor 36. A back surface of the sensor cover 37 may reflect infrared light at a predetermined reflectance. The back surface of the sensor cover 37 may be a surface, of the sensor cover 37, on side of the density sensor 36. Accordingly, in the image forming apparatus 1, the light-emitting diode 36A may be caused to output infrared light and the phototransistor 36B may be caused to receive light diffusely reflected by the back surface of the sensor cover 37, when the sensor cover 37 covers the detection surface of the density sensor 36. This allows for adjusting of a current to be flown through the light-emitting diode 36A.

The cleaning blade 38 may scrape off a substance attached to the transfer surface of the intermediate transfer belt 32 and thereby clean the transfer surface of the intermediate transfer belt 32. Non-limiting examples of the substance attached to the transfer surface of the intermediate transfer belt 32 may include toner remained thereon. In this example, the cleaning blade 38 may be disposed downstream of the secondary transfer section 40, and be in contact with the transfer surface of the intermediate transfer belt 32. The cleaning blade 38 may include, for example but not limited to, a flexible member. The flexible member may include a material such as rubber or plastic.

The waste toner container 39 may contain the substance attached to the transfer surface of the intermediate transfer belt 32 and scraped off by the cleaning blade 38.

As illustrated in FIG. 1, the image forming apparatus 1 may further include a print medium cassette 11, a hopping roller 12, a print medium sensor 13, a pinching roller 14, a registration roller 15, a secondary transfer roller 41, a print medium sensor 42, a fixing section 50, a print medium sensor 43, a conveying roller 44, a conveying roller 45, and a discharging roller 46. The foregoing members may be disposed along the conveyance path 8 along which the print medium 9 is to be conveyed. The conveyance path 8 may be provided with an unillustrated guide that guides the print medium 9. The print medium 9 may be guided by the foregoing guide and thereby conveyed in a conveyance direction F2 along the conveyance path 8.

The print medium cassette 11 may contain the print medium 9 on which an image is to be formed.

The hopping roller 12 may pick up the print medium 9 from the print medium cassette 11, and convey, along the conveyance path 8, the print medium 9 picked up. The hopping roller 12 may be rotated by power transmitted from a hopping motor 81 which will be described later.

The print medium sensor 13 may detect passage of the print medium 9. The print medium sensor 13 may be disposed between a position provided with the hopping roller 12 and a position provided with the pinching roller 14 and the registration roller 15. The print medium sensor 13 may detect, for example, arrival of a tip of the print medium 9 at a position where the pinching roller 14 and the registration roller 15 are disposed.

The pinching roller 14 may correct a skew of the print medium 9 that passes the conveyance path 8. The pinching roller 14 may face the registration roller 15 with the conveyance path 8 in between. The registration roller 15 may feed the print medium 9 toward the secondary transfer section 40 along the conveyance path 8. The registration roller 15 may face the pinching roller 14 with the conveyance path 8 in between. The registration roller 15 may be rotated by power transmitted from a registration motor 82 which will be described later.

The secondary transfer roller 41 may be directed to transfer, onto the transfer surface of the print medium 9, the toner image on the transfer surface of the intermediate transfer belt 32. The secondary transfer roller 41 may include, for example but not limited to, a metal shaft and electrically-conductive urethane foam. The urethane foam included in the secondary transfer roller 41 may have volume resistivity, for example but not limited to, from about 10⁷ Ω·cm to about 10⁹ Ω·cm. The secondary transfer roller 41 may face the secondary transfer opposed roller 35 with the conveyance path 8 and the intermediate transfer belt 32 in between. The secondary transfer roller 41 may be pressed against the secondary transfer opposed roller 35 with a predetermined pressing amount. The secondary transfer roller 41 and the secondary transfer opposed roller 35 may be included together in the secondary transfer section 40. This allows, in the image forming apparatus 1, the toner image on the transfer surface of the intermediate transfer belt 32 to be transferred onto the transfer surface of the print medium 9. In other words, this allows secondary transfer to be performed. The print medium sensor 42 may detect passage of the print medium 9.

The print medium sensor 42 may be disposed between the secondary transfer section 40 and the fixing section 50. The print medium sensor 42 may detect, for example but not limited to, wounding of the print medium 9 around the secondary transfer roller 41 and close attachment of the print medium 9 to the intermediate transfer belt 32.

The fixing section 50 may apply heat and pressure to the print medium 9 fed from the secondary transfer section 40, and thereby fix, to the print medium 9, the toner image transferred onto the print medium 9. The fixing section 50 may include a heating roller 51, a pressure applying roller 53, and a thermistor 54. The heating roller 51 may include a heater 52 inside the heating roller 51.

Non-limiting examples of the heater 52 may include a halogen lamp. The heating roller 51 may apply heat to the toner on the print medium 9. The heating roller 51 may be rotated by power transmitted from a heating motor 84 which will be described later. The pressure applying roller 53 may be so disposed that a pressure-contact is provided between the pressure applying roller 53 and the heating roller 51. The pressure applying roller 53 may apply pressure to the toner on the print medium 9. The thermistor 54 may detect a temperature of the heating roller 51. In other words, the thermistor 54 may detect a fixing temperature. Thus, the toner on the print medium 9 may be heated, melted, and applied with pressure in the fixing section 50. As a result, the toner image may be fixed to the print medium 9.

The print medium sensor 43 may detect passage of the print medium 9. The print medium sensor 43 may be disposed between the fixing section 50 and the conveying roller 44. The print medium sensor 43 may detect, for example, jam of the print medium 9 in the fixing section 50 and winding of the print medium 9 around the heating roller 51.

The conveying roller 44 may include a pair of rollers that are disposed with the conveyance path 8 in between. The conveying roller 44 may convey, along the conveyance path 8, the print medium 9 fed from the fixing section 50. The conveying roller 45 may include a pair of rollers that are disposed with the conveyance path 8 in between. The conveying roller 45 may convey, toward the discharging roller 46, the print medium 9 conveyed along the conveyance path 8.

Each of the conveying roller 44 and the conveying roller 45 may be rotated by power transmitted from a conveying motor 86 which will be described later.

The discharging roller 46 may include a pair of rollers that are disposed with the conveyance path 8 in between. The discharging roller 46 may discharge the print medium 9 to a stacker 47 provided outside of the image forming apparatus 1.

The discharging roller 46 may be rotated by power transmitted from the conveying motor 86 which will be described later.

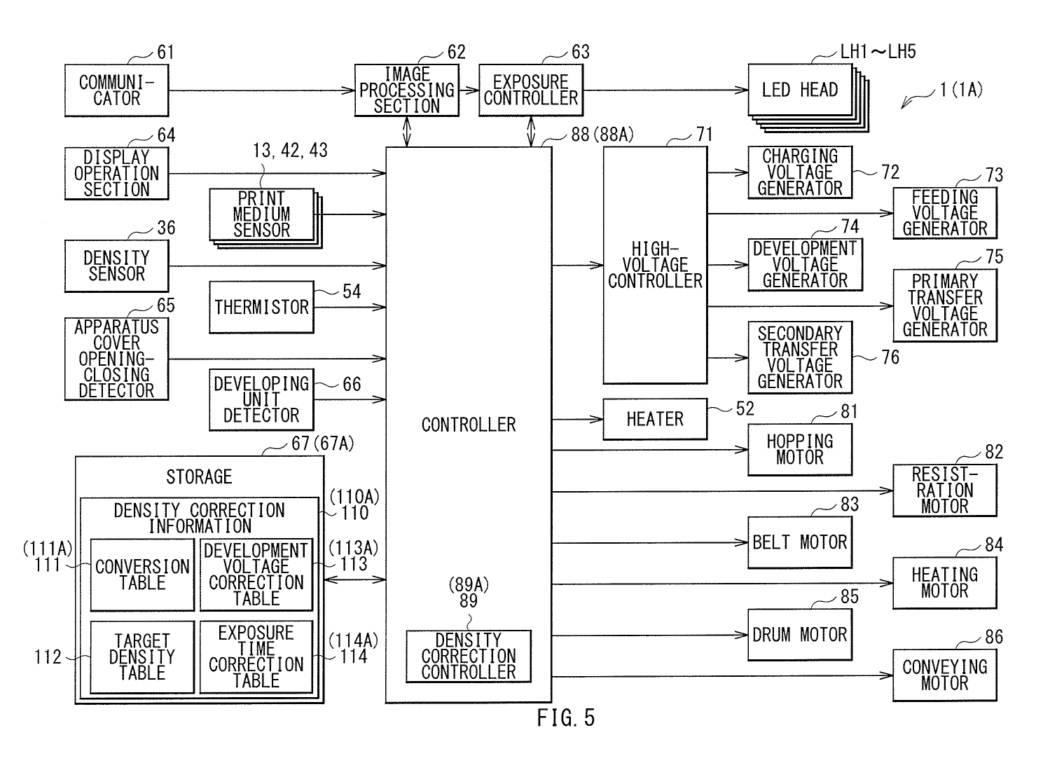

FIG. 5 illustrates an example of a control mechanism of the image forming apparatus 1. The image forming apparatus 1 may include a communicator 61, an image processing section 62, the exposure controller 63, a display operation section 64, an apparatus cover opening-closing detector 65, the developing unit detector 66, storage 67, a high-voltage controller 71, the charging voltage generator 72, the feeding voltage generator 73, the development voltage generator 74, the primary transfer voltage generator 75, the secondary transfer voltage generator 76, the hopping motor 81, the registration motor 82, the belt motor 83, the heating motor 84, the drum motor 85, the conveying motor 86, and a controller 88.

The communicator 61 may perform communication by means of, for example but not limited to, a universal serial bus (USB) or a local area network (LAN). The communicator 61 may receive print data DP supplied from an unillustrated host computer, for example. The communicator 61 may include, for example but not limited to, a connector and a communication large-scale integrated circuit (LSI).

The image processing section 62 may analyze a command and image data both included in the print data DP. The image processing section 62 may also expand the analyzed image data and generate bitmap data corresponding to each color. The image processing section 62 may include, for example but not limited to, a microprocessor, a random-access memory (RAM), and dedicated hardware.

The exposure controller 63 may generate an image signal to be supplied to each of the LED heads LH1 to LH5 on the basis of the bitmap data of the corresponding color generated by the image processing section 62. The exposure controller 63 may supply each of the one or more LED heads LH corresponding to the one or more developing units 20 in the down state DN with an image signal of the color corresponding to the relevant developing unit 20. The foregoing one or more developing units 20 in the down state DN may be of the developing units 20 set in the respective stations ST1 to ST5. The exposure controller 63 may include, for example but not limited to, a semi-custom LSI and a RAM.

The display operation section 64 may receive operation performed by a user. Further, the display operation section 64 may display information such as an operation state of the image forming apparatus 1 or an instruction to the user. The display operation section 64 may include, for example, components such as a liquid crystal display, various indicators, or various buttons.

The apparatus cover opening-closing detector 65 may detect opening and closing of an apparatus cover. For example, as described above, the user may allow the developing unit 20 to be in an operable state by opening the apparatus cover and allowing the developing unit 20 to be in the down state DN in the image forming apparatus 1. Further, the user may allow the developing unit 20 to be in a non-operable state by allowing the developing unit 20 to be in the up state UP in the image forming apparatus 1. The apparatus cover opening-closing detector 65 may be able to detect such opening and closing of the apparatus cover described above.

The developing unit detector 66 may acquire information related to the developing units 20 set to the respective stations ST1 to ST5. For example, the developing unit detector 66 may communicate with the IC tag 28 of each of the developing units 20. The developing unit detector 66 may thereby acquire information related to which station ST of the stations ST1 to ST5 the relevant developing unit 20 is set to and information related to the color of the toner to be used in the developing unit 20 set to each of the stations ST1 to ST5. The developing unit detector 66 may be also allowed to acquire information related to whether the state of the developing unit 20 set to each of the stations ST1 to ST5 is in the up state UP or the down state DN, i.e., the non-operable state and the operable state.

The storage 67 may hold information related to various settings of the image forming apparatus 1. The storage 67 may hold density correction information 110. The density correction information 110 may be used when the image forming apparatus 1 performs the density correction process by utilizing the density detection pattern PAT formed on the transfer surface of the intermediate transfer belt 32. The density correction information 110 may include a conversion table 111, a target density table 112, a development voltage correction table 113, and an exposure time correction table 114.

The conversion table 111 may include information related to a conversion coefficient directed to conversion of the detected value V into a toner density OD. The detected value V may be outputted by the density sensor 36.

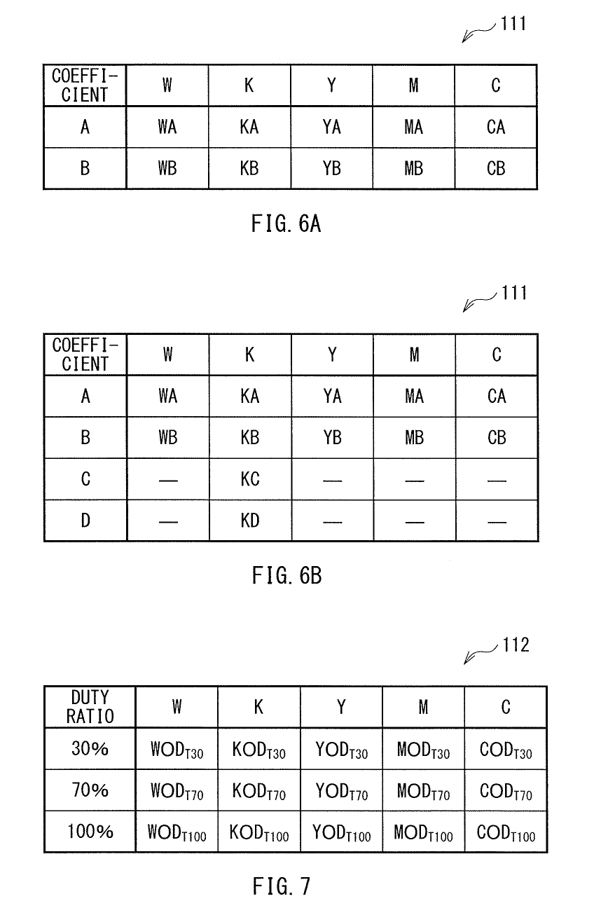

FIG. 6A illustrates an example of the conversion table 111. The conversion table 111 may include two conversion coefficients related to the toner of each color, i.e., conversion coefficients A and B both related to the toner of each color. In this example, the toner density OD may be expressed by the following linear function by the use of the detected value V.

OD=A×V+B

As illustrated in FIG. 6A, the conversion table 111 may include two conversion coefficients A and B both related to the toner of white (W), two conversion coefficients A and B both related to the toner of black (K), two conversion coefficients A and B both related to the toner of yellow (Y), two conversion coefficients A and B both related to the toner of magenta (M), and two conversion coefficients A and B both related to the toner of cyan (C). The two conversion coefficients A and B both related to the toner of white (W) may be conversion coefficients WA and WB. The two conversion coefficients A and B both related to the toner of black (K) may be conversion coefficients KA and KB. The two conversion coefficients A and B both related to the toner of yellow (Y) may be conversion coefficients YA and YB. The two conversion coefficients A and B both related to the toner of magenta (M) may be conversion coefficients MA and MB. The two conversion coefficients A and B both related to the toner of cyan (C) may be conversion coefficients CA and CB.

The toner density OD may be expressed by the linear function by the use of the detected value V in this example; however, this is non-limiting. Alternatively, the toner density OD may be expressed by a higher-dimension function such as a quadratic function or a cubic function.

FIG. 6B illustrates another example of the conversion table 111. In this example, the conversion table 111 may include four conversion coefficients related to the toner of black (K), i.e., conversion coefficients A, B, C, and D. The toner density OD of the toner of black may be expressed by the following cubic function by the use of the detected value V.

OD=D×V³+C×V²+A×V+B

In the example illustrated in FIG. 6B, the conversion table 111 may include the four conversion coefficients A, B, C, and D all related to the toner of black (K), i.e., conversion coefficients KA, KB, KC, and KD.

The target density table 112 may include information related to a target value of a toner density, i.e., a target toner density OD_{T}.

FIG. 7 illustrates an example of the target density table 112. The target density table 112 may include a target toner density OD_{T30} for a duty ratio of 30%, a target toner density OD_{T70} for a duty ratio of 70%, and a target toner density OD_{T100} for a duty ratio of 100%, for the toner of each color. As will be described later, the density detection pattern PAT formed on the transfer surface of the intermediate transfer belt 32 may include a portion having the duty ratio of 30%, a portion having the duty ratio of 70%, and a portion having the duty ratio of 100%. In correspondence therewith, the target density table 112 may include the target toner density OD_{T30} for the duty ratio of 30%, the target toner density OD_{T70} for the duty ratio of 70%, and the target toner density OD_{T100} for the duty ratio of 100%. As illustrated in FIG. 7, the target density table 112 may include: the target toner densities OD_{T30}, OD_{T70}, and OD_{T100} of the toner of white (W), i.e., target toner densities WOD_{T30}, WOD_{T70}, and WOD_{T100}; the target toner densities OD_{T30}, OD_{T70}, and OD_{T100} of the toner of black (K), i.e., target toner densities KOD_{T30}, KOD_{T70}, and KOD_{T100}; the target toner densities OD_{T30}, OD_{T70}, and OD_{T100} of the toner of yellow (Y), i.e., target toner densities YOD_{T30}, YOD_{T70}, and YOD_{T100}; the target toner densities OD_{T30}, OD_{T70}, and OD_{T100} of the toner of magenta (M), i.e., target toner densities MOD_{T30}, MOD_{T70}, and MOD_{T100}; and the target toner densities OD_{T30}, OD_{T70}, and OD_{T100} of the toner of cyan (C), i.e., target toner densities COD_{T30}, COD_{T70}, and COD_{T100}.

The development voltage correction table 113 may include information related to a variation amount ΔDB of the toner density in a case where the development voltage is varied by 1 (one) [V].

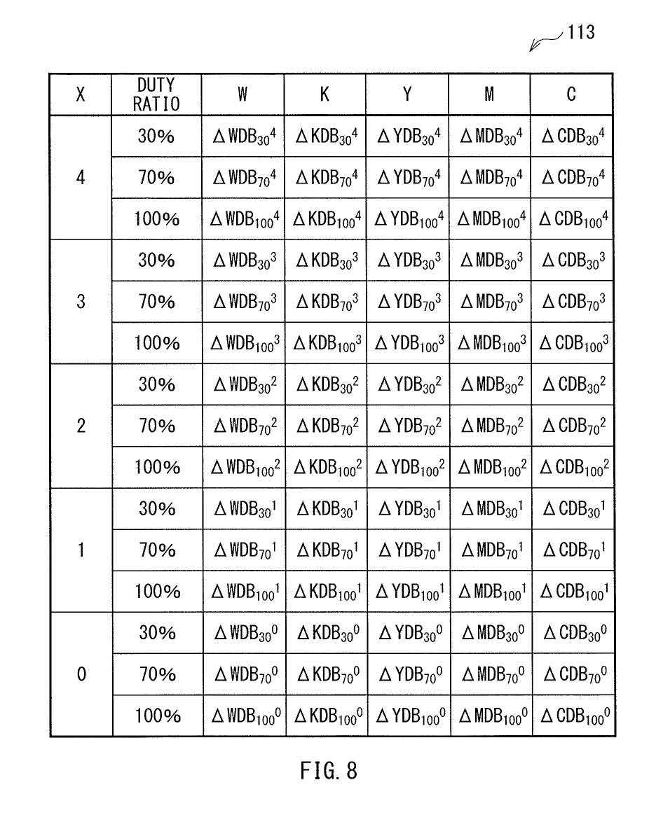

FIG. 8 illustrates an example of the development voltage correction table 113. The development voltage correction table 113 may include a variation amount ΔDB₃₀^{X} of the toner density for the duty ratio of 30%, a variation amount ΔDB₇₀^{X} of the toner density for the duty ratio of 70%, and a variation amount ΔDB₁₀₀^{X} of the toner density for the duty ratio of 100%, for the toner of each color. When attention is paid to any of the developing units 20, the developing unit 20 to which the attention is paid may be referred to as the “developing unit 20 of interest” hereinafter. In this example, a parameter X indicates the number of the developing units 20 set operably and positioned downstream of the developing unit 20 of interest. The image forming apparatus 1 may include the five stations ST. Therefore, a possible value of the parameter X may be 0 (zero) or greater and 4 or smaller. As illustrated in FIG. 8, the development voltage correction table 113 may include: variation amounts ΔDB₃₀^{X}, ΔDB₇₀^{X}, and ΔDB₁₀₀^{X} of the toner density of the toner of white (W), i.e., variation amounts ΔWDB₃₀^{X}, ΔWDB₇₀^{X}, and ΔWDB₁₀₀^{X}; variation amounts ΔDB₃₀^{X}, ΔDB₇₀^{X}, and ΔDB₁₀₀^{X} of the toner density of the toner of black (K), i.e., variation amounts ΔKDB₃₀^{X}, ΔKDB₇₀^{X}, and ΔKDB₁₀₀^{X}; variation amounts ΔDB₃₀^{X}, ΔDB₇₀^{X}, and ΔDB₁₀₀^{X} of the toner density of the toner of yellow (Y), i.e., variation amounts ΔYDB₃₀^{X}, ΔYDB₇₀^{X}, and ΔYDB₁₀₀^{X}; variation amounts ΔDB₃₀^{X}, ΔDB₇₀^{X}, and ΔDB₁₀₀^{X} of the toner density of the toner of magenta (M), i.e., variation amounts ΔMDB₃₀^{X}, ΔMDB₇₀^{X}, and ΔMDB₁₀₀^{X}; and variation amounts ΔDB₃₀^{X}, ΔDB₇₀^{X}, and ΔDB₁₀₀^{X} of the toner density of the toner of cyan (C), i.e., variation amounts ΔCDB₃₀^{X}, ΔCDB₇₀^{X}, and ΔCDB₁₀₀^{X}.

The exposure time correction table 114 may include information related to a variation amount ΔDK of the toner density in a case where the exposure time is varied by 1 (one) [%].

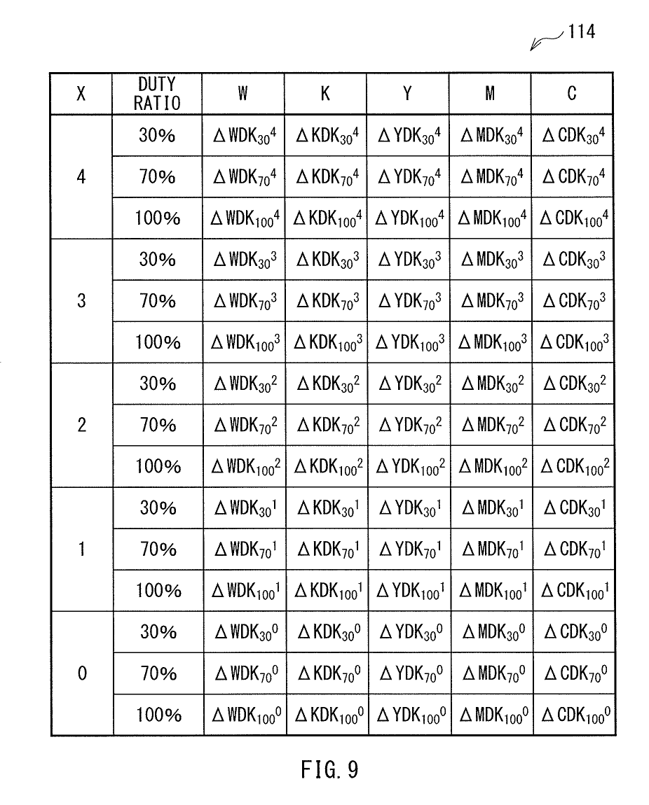

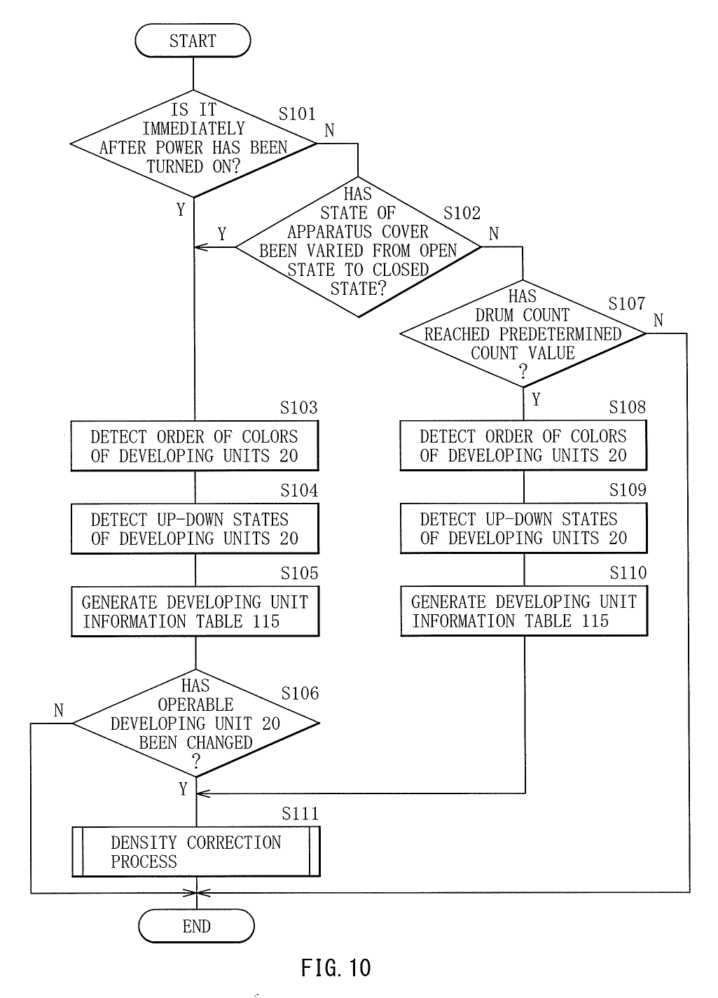

FIG. 9 illustrates an example of the exposure time correction table 114. The exposure time correction table 114 may include a variation amount ΔDK₃₀^{X} of the toner density for the duty ratio of 30%, a variation amount ΔDK₇₀^{X} of the toner density for the duty ratio of 70%, and a variation amount ΔDK₁₀₀^{X} of the toner density for the duty ratio of 100%, for the toner of each color. In this example, a possible value of a parameter X may be 0 (zero) or greater and 4 or smaller, as with in the development voltage correction table 113. As illustrated in FIG. 9, the exposure time correction table 114 may include: variation amounts ΔDK₃₀^{X}, ΔDK₇₀^{X}, and ΔDK₁₀₀^{X} of the toner density of the toner of white (W), i.e., variation amounts ΔWDK₃₀^{X}, ΔWDK₇₀^{X}, and ΔWDK₁₀₀^{X}; variation amounts ΔDK₃₀^{X}, ΔDK₇₀^{X}, and ΔDK₁₀₀^{X} of the toner density of the toner of black (K), i.e., variation amounts ΔKDK₃₀^{X}, ΔKDK₇₀, and ΔKDK₁₀₀^{X}; variation amounts ΔDK₃₀^{X}, ΔDK₇₀^{X}, and ΔDK₁₀₀^{X} of the toner density of the toner of yellow (Y), i.e., variation amounts ΔYDK₃₀^{X}, ΔYDK₇₀^{X}, and ΔYDK₁₀₀^{X}; variation amounts ΔDK₃₀^{X}, ΔDK₇₀^{X}, and ΔDK₁₀₀^{X} of the toner density of the toner of magenta (M), i.e., variation amounts ΔMDK₃₀^{X}, ΔMDK₇₀, and ΔMDK₁₀₀ and variation amounts ΔDK₃₀^{X}, ΔDK₇₀^{X}, and ΔDK₁₀₀^{X} of the toner density of the toner of cyan (C), i.e., variation amounts ΔCDK₃₀^{X}, ΔCDK₇₀^{X}, and ΔCDK₁₀₀^{X}.

The high-voltage controller 71 illustrated in FIG. 5 may control, on the basis of an instruction given from the controller 88, operation of generating various voltages to be used in the image forming apparatus 1. The high-voltage controller 71 may include, for example but not limited to, a device such as a microprocessor or a custom LSI.

The charging voltage generator 72 may generate, on the basis of an instruction given from the high-voltage controller 71, a charging voltage to be supplied to each of the one or more developing units 20 in the down state DN. The one or more developing units 20 in the down state DN may be of the developing units 20 set to the respective stations ST1 to ST5.

The feeding voltage generator 73 may generate, on the basis of an instruction given from the high-voltage controller 71, a feeding voltage to be supplied to each of the one or more developing units 20 in the down state DN. The one or more developing units 20 in the down state DN may be of the developing units 20 set to the respective stations ST1 to ST5.

The development voltage generator 74 may generate, on the basis of an instruction given from the high-voltage controller 71, a development voltage to be supplied to each of the one or more developing units 20 in the down state DN. The one or more developing units 20 in the down state DN may be of the developing units 20 set to the respective stations ST1 to ST5.

The primary transfer voltage generator 75 may generate, on the basis of an instruction given from the high-voltage controller 71, a primary transfer voltage to be supplied to each of the primary transfer rollers TR1 to TR5. The primary transfer voltage generator 75 may generate the primary transfer voltage to be supplied to the primary transfer roller TR corresponding to each of the one or more developing units 20 in the down state DN. The one or more developing units 20 in the down state DN may be of the developing units 20 set to the respective stations ST1 to ST5.

The secondary transfer voltage generator 76 may generate, on the basis of an instruction given from the high-voltage controller 71, a second transfer voltage to be supplied to the secondary transfer opposed roller 35.

The hopping motor 81 may generate, on the basis of an instruction given from the controller 88, power to be transmitted to the hopping roller 12 illustrated in FIG. 1. The registration motor 82 may generate, on the basis of an instruction given from the controller 88, power to be transmitted to the registration roller 15 illustrated in FIG. 1. The belt motor 83 may generate, on the basis of an instruction given from the controller 88, power to be transmitted to the driving roller 33 illustrated in FIG. 1. The heating motor 84 may generate, on the basis of an instruction from the controller 88, power to be transmitted to the heating roller 51 illustrated in FIG. 1. The drum motor 85 may generate, on the basis of an instruction given from the controller 88, power to be transmitted to the one or more developing units 20 in the down state DN. The one or more developing units 20 in the down state DN may be of the developing units 20 set to the respective stations ST1 to ST5. The conveying motor 86 may generate, on the basis of an instruction given from the controller 88, power to be transmitted to the conveying roller 44, the conveying roller 45, and the discharging roller 46 illustrated in FIG. 1.

The controller 88 may control general operation of the image forming apparatus 1 by controlling operation of each block in the image forming apparatus 1 on the basis of an instruction given from the image processing section 62. The controller 88 may control, on the basis of a result of a detection performed by each of the print medium sensors 13, 42, and 43, operation of conveying the print medium 9 in the image forming apparatus 1. The controller 88 may control a fixing temperature of the fixing section 50 by controlling operation of the heater 52 on the basis of a result of the detection performed by the thermistor 54.

The controller 88 may include a density correction controller 89. The density correction controller 89 may control the density correction process in the image forming apparatus 1. For example, the density correction controller 89 may so perform a control that the image forming apparatus 1 performs the density correction process, for example but not limited to, when any of the one or more developing units 20 operably set to the stations ST1 to ST5 has been changed, or when a drum count reaches a predetermined count value. The drum count may indicate an accumulated rotation number of the photosensitive drum 21 in each of the developing units 20. In the density correction process, the density correction controller 89 may so control the operation of each block in the image forming apparatus 1 that the density detection pattern PAT is to be formed on the transfer surface of the intermediate transfer belt 32. Further, the density correction controller 89 may so correct each of the development voltage and the exposure time that the toner density becomes closer to the target value. The density correction controller 89 may perform such correction on the basis of the result of the detection performed by the density sensor 36 and the density correction information 110 stored in the storage 67.

The photosensitive drum 21 may correspond to a “photosensitive member” in one specific but non-limiting embodiment of the technology. The developing unit detector 66 may correspond to a “detector” in one specific but non-limiting embodiment of the technology. The development voltage generator 74 may correspond to a “voltage application unit” in one specific but non-limiting embodiment of the technology. The LED head LH may correspond to an “exposure unit” in one specific but non-limiting embodiment of the technology. The intermediate transfer belt 32 may correspond to an “image conveying member” in one specific but non-limiting embodiment of the technology. The primary transfer roller TR may correspond to a “primary transfer member” in one specific but non-limiting embodiment of the technology. The density sensor 36 may correspond to a “sensor” in one specific but non-limiting embodiment of the technology. The secondary transfer roller 41 and the secondary transfer opposed roller 35 may correspond to a “secondary transfer member” in one specific but non-limiting embodiment of the technology. The density correction controller 89 may correspond to a “setting unit” in one specific but non-limiting embodiment of the technology. The developing unit information table 115 may correspond to “developing unit information” in one specific but non-limiting embodiment of the technology.

### [Example Operation and Example Workings]

A description is given next of example operation and example workings of the image forming apparatus 1 according to the first example embodiment.

### [Outline of General Operation]

A description is given first of an outline of general operation of the image forming apparatus 1 referring to FIGS. 1, 2, and 5. When the communicator 61 receives the print data DP supplied from a host computer, the image processing section 62 may instruct the controller 88 to warm up the heater 52. When the communicator 61 receives the print data DP supplied from the host computer, the image processing section 62 may also expand the image data included in the print data DP, and thereby generate bitmap data corresponding to each color. The controller 88 may cause, on the basis of an instruction given from the image processing section 62, the heating motor 84 to operate. The controller 88 may also control, by causing the heater 52 to operate, the fixing temperature of the fixing section 50 to be a predetermined temperature appropriate for the fixing operation. On a condition that the bitmap data corresponding to a single page has been stored in the RAM and the fixing temperature has reached the predetermined temperature, the image processing section 62 may instruct the controller 88 to start the image forming operation.

The controller 88 may cause, on the basis of an instruction given from the image processing section 62, each of the belt motor 83 and the drum motor 85 to operate. The intermediate transfer belt 32 may be thereby conveyed circularly, and the one or more developing units 20 in the down state DN may thereby perform the developing operation. The one or more developing units 20 in the down state DN may be of the developing units 20 set to the respective stations ST1 to ST5. The high-voltage controller 71 may cause, on the basis of an instruction given from the controller 88, each of the charging voltage generator 72, the feeding voltage generator 73, and the development voltage generator 74 to operate. The charging voltage generator 72 may thereby apply the charging voltage to the charging roller 23 of each of the one or more developing units 20 in the down state DN. The feeding voltage generator 73 may thereby apply the feeding voltage to the feeding roller of each of the one or more developing units 20 in the down state DN. The development voltage generator 74 may thereby apply the development voltage to the developing roller 24 of each of the one or more developing units 20 in the down state DN. The charging roller 23 may electrically charge the photosensitive drum 21. The image processing section 62 may supply the exposure controller 63 with bitmap data corresponding to a single line that is stored in the RAM. The exposure controller 63 may generate an image signal corresponding to each color on the basis of bitmap data corresponding to a single line of the relevant color. The exposure controller 63 may also supply the LED head LH corresponding to each of the one or more developing units 20 in the down state DN with the image signal corresponding to the color of the toner of the relevant developing unit 20. The one or more developing units 20 in the down state DN may be of the developing units 20 set to the respective stations ST1 to ST5. The LED heads LH may each perform exposure of the photosensitive drum 21 on a dot-unit basis. The LED heads LH may each perform the foregoing exposure on the basis of the received image signal. Thus, an electrostatic latent image may be formed on the photosensitive drum 21. The electrostatic latent image formed on the photosensitive drum 21 may arrive at a contact portion where the photosensitive drum 21 and the developing roller 24 are in contact with each other, as a result of the rotation of the photosensitive drum 21. Each of the development voltage applied to the developing roller 24 and the feeding voltage applied to the feeding roller 26 may be a negative voltage. As a result, the toner negatively charged as a result of frictional electrification may be fed to the developing roller 24. The foregoing negatively-charged toner may form a toner layer on the developing roller 24. A thickness of the toner layer may be controlled by the developing blade 25. Further, the toner included in the foregoing toner layer may be selectively moved from the developing roller 24 to the photosensitive drum 21 by an electric field at the contact portion where the photosensitive drum 21 and the developing roller 24 are in contact with each other. Thus, a toner image based on the electrostatic latent image may be formed in each of the developing units 20. In other words, development may be performed in each of the developing units 20. The above-described developing operation may be performed only in the one or more developing units 20 in the down state DN, and may not be performed in the one or more developing units 20 in the up state UP.

The high-voltage controller 71 may cause, on the basis of an instruction given from the controller 88, each of the primary transfer voltage generator 75 and the secondary transfer voltage generator 76 to operate. The primary transfer voltage generator 75 may thereby apply the primary transfer voltage to the primary transfer roller TR of each of the one or more developing units 20 in the down state DN. The one or more developing units 20 in the down state DN may be of the developing units 20 set to the respective stations ST1 to ST5. The secondary transfer voltage generator 76 may thereby apply the secondary transfer voltage to the secondary transfer opposed roller 35. Accordingly, the toner image on the photosensitive drum 21 of each of the one or more developing units 20 in the down state DN may be transferred onto the intermediate transfer belt 32.

In other words, primary transfer may be performed. As a result, the toner images of the respective colors may be superimposed on each other on the intermediate transfer belt 32. When the intermediate transfer belt 32 is conveyed circularly and the transferred toner image is thereby positioned closer to the secondary transfer section 40, the controller 88 may cause the hopping motor 81 to operate. The hopping roller 12 may thereby pick up one print medium 9 from the print medium cassette 11, and convey the picked-up print medium 9 along the conveyance path 8. When the print medium sensor 13 detects the arrival of the tip of the print medium 9 at a position where the pinching roller 14 and the registration roller 15 are disposed, the controller 88 may stop the operation of the hopping motor 81. Thereafter, the controller 88 may cause the registration motor 82 to operate. Accordingly, the registration roller 15 may rotate, thereby feeding the print medium 9 to the secondary transfer section 40. When the print medium 9 arrives at the position, in the secondary transfer section 40, where the secondary transfer roller 41 and the secondary transfer opposed roller 35 are disposed, the toner image on the intermediate transfer belt 32 may be transferred onto the print medium 9. In other words, secondary transfer may be performed.

In the fixing section 50, the temperature of the heating roller 51 may have already reached the predetermined temperature appropriate for the fixing operation. Therefore, the toner image on the print medium 9 may be fixed to the print medium 9 by the heating roller 51 and the pressure applying roller 53. Further, the print medium 9 with the fixed toner image may be discharged to the stacker 47 by the conveying roller 44, the conveying roller 45, and the discharging roller 46.

### [Detailed Operation]

A detailed description is given next of the density correction process.

FIG. 10 illustrates an example of operation of the image forming apparatus 1. The density correction controller 89 may so perform the control that the image forming apparatus 1 performs the density correction process, for example but not limited to, when any of the one or more developing units 20 operably set to the stations ST1 to ST5 has been changed, or when the drum count reaches the predetermined count value. The drum count may indicate the accumulated rotation number of the photosensitive drum 21 in each of the developing units 20. This operation is described in detail below.

First, the image forming apparatus 1 may confirm whether it is immediately after the power has been turned on (step S101). When it is immediately after the power has been turned on (“Y” in step S101), the flow may proceed to step S103.

When it is not immediately after the power has been turned on in step S101 (“N” in step S101), the apparatus cover opening-closing detector 65 may confirm whether the state of the apparatus cover has been varied from an open state to a closed state (step S102). When the state of the apparatus cover has been varied from the open state to the closed state (“Y” in step S102), the flow may proceed to step S103. When the state of the apparatus cover has not been varied from the open state to the closed state (“N” in step S102), the flow may proceed to step S107.

Thereafter, the developing unit detector 66 may detect the order of the colors of the developing units 20 set to the respective stations ST1 to ST5 (step S103). For example, the developing unit detector 66 may acquire information related to which station ST of the stations ST1 to ST5 is set with the developing unit 20 and information related to the color of the toner to be used in each of the developing units 20 set in the stations ST1 to ST5. The developing unit detector 66 may acquire the pieces of information described above by communicating with the IC tag 28 of each of the developing units 20.

Thereafter, the developing unit detector 66 may detect an up-down state of each of the developing units 20 (step S104). For example, the developing unit detector 66 may acquire information related to whether the state of the developing unit 20 set to each of the stations ST1 to ST5 is the up state UP or the down state DN, i.e., the non-operable state or the operable state.

Thereafter, the density correction controller 89 may generate the developing unit information table 115 on the basis of results of the detections performed in respective steps S103 and S104 (step S105).

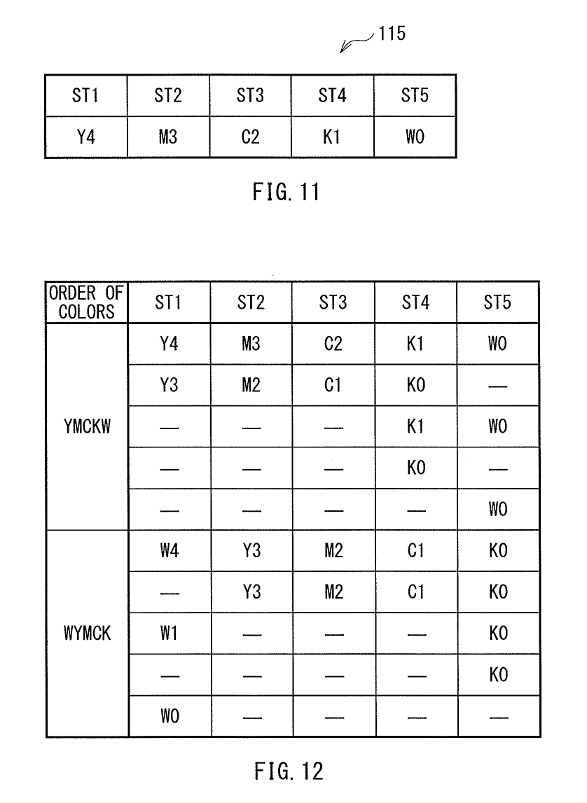

FIG. 11 illustrates an example of the developing unit information table 115. The developing unit information table 115 may include information related to the color of each of the one or more developing units 20 in the down state DN, of the developing units 20 set to the stations ST1 to ST5. The developing unit information table 115 may also include information related to the number of the developing units 20 that are in the down state DN and positioned downstream of the developing unit 20 of interest. In this example, the developing unit information table 115 includes pieces of information “Y4”, “M3”, “C2”, “K1”, and “W0” corresponding to the stations ST1, ST2, ST3, ST4, and ST5, respectively.

For example, as illustrated in FIG. 1, the order of colors in the respective stations ST1 to ST5 is “YMCKW”, and all of the developing units 20 are in the down state DN in this example. Accordingly, the information corresponding to the station ST1 is “Y4” on the basis of the condition that the developing unit 20Y is set to the station ST1 and the four developing units 20M, 20C, 20K, and 20W are positioned downstream of the developing unit 20Y and set in the down state DN. The information corresponding to the station ST2 is “M3” on the basis of the condition that the developing unit 20M is set to the station ST2 and the three developing units 20C, 20K, and 20W are positioned downstream of the developing unit 20M and set in the down state DN. The information corresponding to the station ST3 is “C2” on the basis of the condition that the developing unit 20C is set to the station ST3 and the two developing units 20K and 20W are positioned downstream of the developing unit 20C and set in the down state DN. The information corresponding to the station ST4 is “K1” on the basis of the condition that the developing unit 20K is set to the station ST4 and the single developing unit 20W is positioned downstream of the developing unit 20K and set in the down state DN. The information corresponding to the station ST5 is “W0” on the basis of the condition that the developing unit 20W is set to the station ST5 and no developing unit 20 is positioned downstream of the developing unit 20W.

FIG. 12 illustrates an example of the developing unit information table 115 in various other cases. For example, in a case where: the order of colors in the stations ST1 to ST5 is “YMCKW”; the developing units 20Y, 20M, 20C, and 20K respectively set to the stations ST1, ST2, ST3, and ST4 are in the down state DN; and only the developing unit 20W set to the station ST5 is in the up state UP, the developing unit information table 115 may include pieces of information “Y3”, “M2”, “C1”, “K0”, and “-” corresponding to the stations ST1, ST2, ST3, ST4, and ST5, respectively. The information corresponding to the station ST1 is “Y3” on the basis of the condition that the developing unit 20Y is set to the station ST1 and the three developing units 20M, 20C, and 20K are positioned downstream of the developing unit 20Y and set in the down state DN. The information corresponding to the station ST2 is “M2” on the basis of the condition that the developing unit 20M is set to the station ST2 and the two developing units 20C and 20K are positioned downstream of the developing unit 20M and set in the down state DN. The information corresponding to the station ST3 is “C1” on the basis of the condition that the developing unit 20C is set to the station ST3 and the single developing unit 20K is positioned downstream of the developing unit 20C and set in the down state DN. The information corresponding to the station ST4 is “K0” on the basis of the condition that the developing unit 20K is set to the station ST4 and no developing unit 20 is positioned downstream of the developing unit 20K and set in the down state DN. The information corresponding to the station ST5 is “-” on the basis of the condition that the developing unit 20W set to the station ST5 is in the up state UP. This may be similarly applicable also to a case where the developing unit 20W is not set to the station ST5.

In another example case where: the developing units 20K and 20W respectively set to the stations ST4 and ST5 are in the down state DN; and the developing units 20Y, 20M, and 20C respectively set to the stations ST1, ST2, and ST3 are in the up state UP, the developing unit information table 115 may include pieces of information “-”, “-”, “-”, “K1”, and “W0” corresponding to the stations ST1, ST2, ST3, ST4, and ST5, respectively. This may be similarly applicable also to a case where the developing units 20Y, 20M, and 20C are not set to the stations ST1, ST2, and ST3, respectively.

In still another example case where: only the developing unit 20K set to the station ST4 is in the down state DN; and the developing units 20Y, 20M, 20C, and 20W respectively set to the stations ST1, ST2, ST3, and ST5 are in the up state UP, the developing unit information table 115 may include pieces of information “-”, “-”, “-”, “K0”, and “-” corresponding to the stations ST1, ST2, ST3, ST4, and ST5, respectively. This may be similarly applicable also to a case where the developing units 20Y, 20M, 20C, and 20W are not set to the stations ST1, ST2, ST3, and ST5, respectively.

In still another example case where: only the developing unit 20W set to the station ST5 is in the down state DN; and the developing units 20Y, 20M, 20C, and 20K respectively set to the stations ST1, ST2, ST3, and ST4 are in the up state UP, the developing unit information table 115 may include pieces of information “-”, “-”, “-”, “-”, and “W0” corresponding to the stations ST1, ST2, ST3, ST4, and ST5, respectively. This may be similarly applicable also to a case where the developing units 20Y, 20M, 20C, and 20K are not set to the stations ST1, ST2, ST3, and ST4, respectively.

In still another example case where: the order of the colors in the stations ST1 to ST5 is “WYMCK”; and all of the developing units 20W, 20Y, 20M, 20C, and 20K respectively set to the stations ST1, ST2, ST3, ST4, and ST5 are in the down state DN, the developing unit information table 115 may include pieces of information “W4”, “Y3”, “M2”, “C1”, and “K0” corresponding to the stations ST1, ST2, ST3, ST4, and ST5, respectively.

In still another example case where: the developing units 20Y, 20M, 20C, and 20K respectively set to the stations ST2, ST3, ST4, and ST5 are in the down state DN; and the developing unit 20W set to the station ST1 is in the up state UP, the developing unit information table 115 may include pieces of information “-”, “Y3”, “M2”, “C1”, and “K0” corresponding to the stations ST1, ST2, ST3, ST4, and ST5, respectively. This may be similarly applicable also to a case where the developing unit 20W is not set to the station ST1.

In still another example case where: the developing units 20W and 20K respectively set to the stations ST1 and ST5 are in the down state DN; and the developing units 20Y, 20M, and 20C respectively set to the stations ST2, ST3, and ST4 are in the up state UP, the developing unit information table 115 may include pieces of information “W1”, “-”, “-”, “-”, and “K0” corresponding to the stations ST1, ST2, ST3, ST4, and ST5, respectively. This may be similarly applicable also to a case where the developing units 20Y, 20M, and 20C are not set to the stations ST2, ST3, and ST4, respectively.

In still another example case where: the developing unit 20K set to the station ST5 is in the down state DN; and the developing units 20W, 20Y, 20M, and 20C respectively set to the stations ST1, ST2, ST3, and ST4 are in the up state UP, the developing unit information table 115 may include pieces of information “-”, “-”, “-”, “-”, and “K0” corresponding to the stations ST1, ST2, ST3, ST4, and ST5, respectively. This may be similarly applicable also to a case where the developing units 20W, 20Y, 20M, and 20C are not set to the stations ST1, ST2, ST3, and ST4, respectively.

In still another example case where: the developing unit 20W set to the station ST1 is in the down state DN; and the developing units 20Y, 20M, 20C, and 20K respectively set to the stations ST2, ST3, ST4, and ST5 are in the up state UP, the developing unit information table 115 may include pieces of information “W0”, “-”, “-”, “-”, and “-” corresponding to the stations ST1, ST2, ST3, ST4, and ST5, respectively. This may be similarly applicable also to a case where the developing units 20Y, 20M, 20C, and 20K are not set to the stations ST2, ST3, ST4, and ST5, respectively.

The density correction controller 89 may generate the developing unit information table 115 such as those described above on the basis of the results of the detection performed in steps S103 and S104.

Thereafter, the density correction controller 89 may confirm whether any of the one or more operable developing units 20 in the stations ST1 to ST5 has been changed (step S106). The density correction controller 89 may perform such confirmation on the basis of the developing unit information table 115 generated in step S105. When any of the one or more operable developing units 20 has not been changed (“N” in step S106), the flow may be brought to an end. Alternatively, when any of the one or more operable developing units 20 has been changed (“Y” in step S106), the flow may proceed to step S111.

When the state of the apparatus cover has not been varied from the open state to the closed state in step S102 (“N” in step S102), the density correction controller 89 may confirm whether the drum count has reached the predetermined count value (step S107). The drum count may indicate the accumulated rotation number of the photosensitive drum 21 in each of the developing units 20. When the drum count has not reached the predetermined count value (“N” in step S107), the flow may be brought to the end.

When the drum count has reached the predetermined count value in step S107 (“Y” in step S107), the developing unit detector 66 may detect the order of the colors of the developing units 20 in the respective stations ST1 to ST5 (step S108), the developing unit detector 66 may detect the up-down state of each of the developing units 20 (step S109), and the density correction controller 89 may generate the developing unit information table 115 on the basis of results of detections performed in respective steps S108 and S109 (step S110), in manners similar to those in steps S103 to S105. Thereafter, the flow may proceed to step S111.

In step S111, the density correction controller 89 may perform the density correction process (step S111).

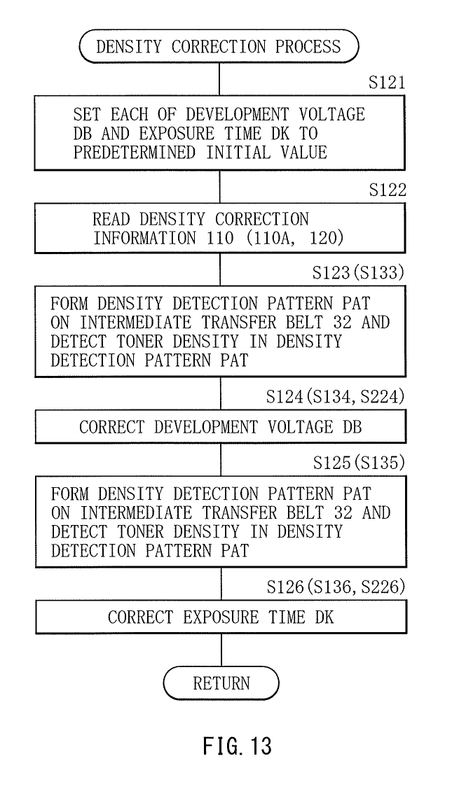

FIG. 13 illustrates an example of a subroutine of the density correction process. The density correction controller 89 may so control the operation of each block in the image forming apparatus 1 that the density detection pattern PAT is formed on the transfer surface of the intermediate transfer belt 32. The density correction controller 89 may so correct each of the development voltage and the exposure time that the toner density becomes closer to the target value. The density correction controller 89 may perform such correction of each of the development voltage and the exposure time on the basis of the result of the detection performed by the density sensor 36 and the density correction information 110 stored in the storage 67. The operation is described in detail below referring to an example case where: the five developing units 20Y, 20M, 20C, 20K, and 20W are set in this order to the stations ST1, ST2, ST3, ST4, and ST5, respectively; and the five developing units 20Y, 20M, 20C, 20K, and 20W are in the down state DN.

First, the density correction controller 89 may set each of a development voltage DB and exposure time DK to a predetermined initial value (step S121). In other words, in step S121, the density correction controller 89 may set the development voltage DB to a development voltage DB₀ and set the exposure time DK to exposure time DK₀. For example, the development voltage DB related to the developing unit 20Y, i.e., a development voltage YDB, may be set to a development voltage YDB₀. The development voltage DB related to the developing unit 20M, i.e., a development voltage MDB, may be set to a development voltage MDB₀. The development voltage DB related to the developing unit 20C, i.e., a development voltage CDB, may be set to a development voltage CDB₀. The development voltage DB related to the developing unit 20K, i.e., a development voltage KDB, may be set to a development voltage KDB₀. The development voltage DB related to the developing unit 20W, i.e., a development voltage WDB, may be set to a development voltage WDB₀. In a similar manner, the exposure time DK related to the developing unit 20Y, i.e., exposure time YDK, may be set to exposure time YDK₀. The exposure time DK related to the developing unit 20M, i.e., exposure time MDK, may be set to exposure time MDK₀. The exposure time DK related to the developing unit 20C, i.e., exposure time CDK, may be set to exposure time CDK₀. The exposure time DK related to the developing unit 20K, i.e., exposure time KDK, may be set to exposure time KDK₀. The exposure time DK related to the developing unit 20W, i.e., exposure time WDK, may be set to exposure time WDK₀.

Thereafter, the density correction controller 89 may read the density correction information 110 stored in the storage 67 (step S122).

Thereafter, the image forming apparatus 1 may form the density detection pattern PAT on the transfer surface of the intermediate transfer belt 32 and detect the toner density in the density detection pattern PAT formed on the intermediate transfer belt 32 (step S123).

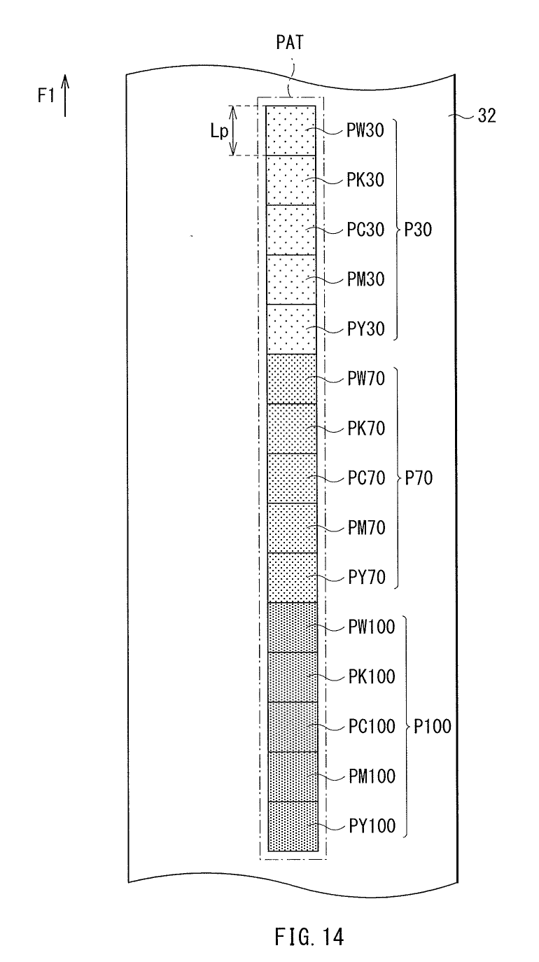

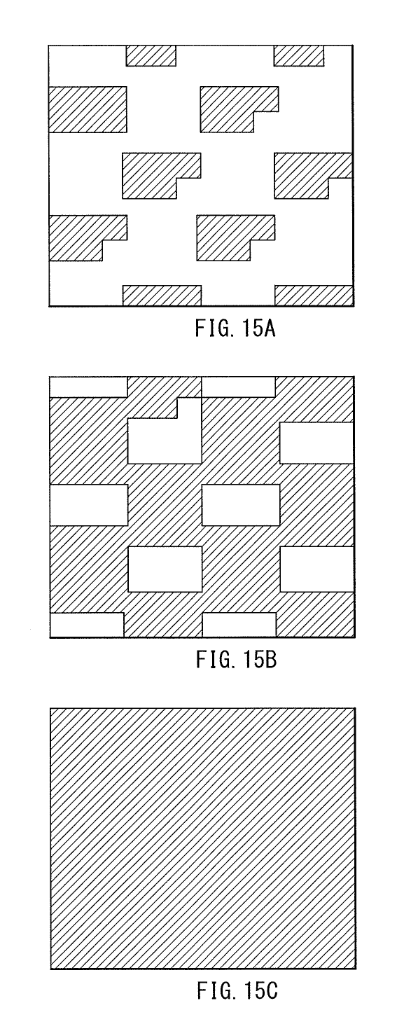

FIG. 14 illustrates an example of the density detection pattern PAT formed on the intermediate transfer belt 32. The density detection pattern PAT may include three patterns, i.e., a pattern P30, a pattern P70, and a pattern P100. The pattern P30 may be a dither pattern having a duty ratio of 30%, as illustrated in FIG. 15A. The duty ratio refers to a ratio of an area provided with a toner. The pattern P70 may be a dither pattern having a duty ratio of 70%, as illustrated in FIG. 15B. The pattern P100 may be a dither pattern having a duty ratio of 100%, as illustrated in FIG. 15C. Each of the dither patterns P30, P70, and P100 may be formed as a halftone dither pattern with an angle of 45 degrees. As illustrated in FIG. 14, the three patterns P30, P70, and P100 may be provided in this order from the downstream toward the upstream in the conveyance direction F1 of the intermediate transfer belt 32.

As illustrated in FIG. 14, the pattern P30 may include five toner images, i.e., toner images PW30, PK30, PC30, PM30, and PY30. The toner image PW30 may be of the toner of white (W). The toner image PK30 may be of the toner of black (K). The toner image PC30 may be of the toner of cyan (C). The toner image PM30 may be of the toner of magenta (M). The toner image PY30 may be of the toner of yellow (Y). The five toner images PW30, PK30, PC30, PM30, and PY30 may be provided in this order from the downstream toward the upstream in the conveyance direction F1 of the intermediate transfer belt 32. This order may correspond to the order of the five developing units 20W, 20K, 20C, 20M, and 20Y respectively set to the stations ST1 to ST5. A length in the conveyance direction F1 of each of the toner images PW30, PK30, PC30, PM30, and PY30 may be set to a predetermined length Lp. Spacing between any adjacent toner images of the toner images PW30, PK30, PC30, PM30, and PY30 may be set to zero. In this example case, the five developing units 20Y, 20M, 20C, 20K, and 20W are in the down state DN. Therefore, five toner images PW30, PK30, PC30, PM30, and PY30 may be formed. This is, however, non-limiting. For example, in a case where any of the five developing units 20 is in the up state UP, the toner image corresponding to the developing unit 20 in the up state UP may not be formed.

Similarly, the pattern P70 may include five toner images, i.e., toner images PW70, PK70, PC70, PM70, and PY70. The pattern P100 may include five toner images, i.e., toner images PW100, PK100, PC100, PM100, and PY100.

The toner images PY30, PY70, and PY100 may each correspond to the toner image PY illustrated in FIG. 4A. The toner images PM30, PM70, and PM100 may each correspond to the toner image PM illustrated in FIG. 4A. The toner images PC30, PC70, and PC100 may each correspond to the toner image PC illustrated in FIG. 4A. The toner images PW30, PW70, and PW100 may each correspond to the toner image PW illustrated in FIG. 4A. The toner images PK30, PK70, and PK100 may each correspond to the toner image PK illustrated in FIG. 4B.

The density detection pattern PAT is not limited to the configuration described above. For example, factors related to the dither pattern such as a type, a configuration, a duty ratio, order of colors, a length of a toner image, or spacing between toner images may be varied where appropriate.

The density sensor 36 may detect the above-described density detection pattern PAT formed on the transfer surface of the intermediate transfer belt 32. For example, first, the light-emitting diode 36A illustrated in FIG. 3 may emit infrared light. Further, as illustrated in FIG. 4A, the phototransistor 36B may receive the infrared light that has been diffusely reflected in the vicinity of the middle of the toner image PW30, and output a detected value WV₃₀, i.e., the detected value V based on an amount of the received light. Thereafter, as illustrated in FIG. 4B, the phototransistor 36C may receive the infrared light that has been specularly reflected in the vicinity of the middle of the toner image PW30, and output a detected value KV₃₀, i.e., the detected value V based on an amount of the received light. Thereafter, as illustrated in FIG. 4A, the phototransistor 36B may receive the infrared light that has been diffusely reflected in the vicinity of the middle of the toner image PC30, and output a detected value CV₃₀, i.e., the detected value V based on an amount of the received light. Thereafter, as illustrated in FIG. 4A, the phototransistor 36B may receive the infrared light that has been diffusely reflected in the vicinity of the middle of the toner image PM30, and output a detected value MV₃₀, i.e., the detected value V based on an amount of the received light. Thereafter, as illustrated in FIG. 4A, the phototransistor 36B may receive the infrared light that has been diffusely reflected in the vicinity of the middle of the toner image PY30, and output a detected value YV₃₀, i.e., the detected value V based on an amount of the received light. In a manner similar to that described above, the density sensor 36 may output detected values WV₇₀, KV₇₀, CV₇₀, MV₇₀, and YV₇₀ on the basis of the toner images PW70, PK70, PC70, PM70, and PY70, respectively. The density sensor 36 may also output detected values WV₁₀₀, KV₁₀₀, CV₁₀₀, MV₁₀₀, and YV₁₀₀ on the basis of the toner images PW100, PK100, PC100, PM100, and PY100, respectively.

The density correction controller 89 may convert the detected value V into the toner density OD by the use of the conversion table 111 such as that illustrated in FIG. 6A. The density correction controller 89 may receive the detected value V from the density sensor 36. For example, the density correction controller 89 may determine, by the use of the following expressions: the toner density WOD₃₀, i.e., the toner density OD of the toner of white for the duty ratio of 30%; the toner density WOD₇₀, i.e., the toner density OD of the toner of white for the duty ratio of 70%; and the toner density WOD₁₀₀, i.e., the toner density OD of the toner of white for the duty ratio of 100%.

WOD₃₀=WA×WV₃₀+WB

WOD₇₀=WA×WV₇₀+WB

WOD₁₀₀=WA×WV₁₀₀+WB

In a manner similar to that described above, the density correction controller 89 may determine the toner density OD of the toner of black, the toner density OD of the toner of cyan, the toner density OD of the toner of magenta, and the toner density OD of the toner of yellow. The toner density OD of the toner of black may include toner densities KOD₃₀, KOD₇₀, and KOD₁₀₀. The toner density OD of the toner of cyan may include toner densities COD₃₀, COD₇₀, and COD₁₀₀. The toner density OD of the toner of magenta may include toner densities MOD₃₀, MOD₇₀, and MOD₁₀₀. The toner density OD of the toner of yellow may include toner densities YOD₃₀, YOD₇₀, and YOD₁₀₀.

In an example case where a cubic function is used as illustrated in FIG. 6B, the density correction controller 89 may determine the toner densities KOD₃₀, KOD₇₀, and KOD₁₀₀ of the toner of black by the use of the following expressions.

KOD₃₀=KD×KV₃₀³+KC×KV₃₀²+KA×KV₃₀+KB

KOD₇₀=KD×KV₇₀³+KC×KV₇₀²+KA×KV₇₀+KB

KOD₁₀₀=KD×KV₁₀₀³+KC×KV₁₀₀²+KA×KV₁₀₀+KB

Thereafter, the image forming apparatus 1 may correct the development voltage DB (step S124). First, the density correction controller 89 may determine a correction amount DBA of the development voltage DB on the basis of the toner density OD that has been determined in step S123. The density correction controller 89 may determine the above-described correction amount DBA by the use of the target density table 112 illustrated in FIG. 7, the development voltage correction table 113 illustrated in FIG. 8, and the developing unit information table 115 illustrated in FIG. 11. For example, the density correction controller 89 may determine, by the use of the following expression, a correction amount WDBA, i.e., the correction amount DBA of the development voltage WDB in the developing unit 20W which is for the color of white.

WDBA={(WOD₃₀−WOD_{T30})/ΔWDB₃₀⁰+(WOD₇₀−WOD_{T70})/ΔWDB₇₀⁰+(WOD₁₀₀−WOD_{T100})/ΔWDB₁₀₀⁰}/3

That is, in this example, the density correction controller 89 may determine a value as a result of dividing, by the variation amount ΔDB (the variation amount ΔWDB₃₀⁰), a difference between the detected toner density WOD₃₀ and the target toner density WOD_{T30} in the case with the duty ratio of 30%. The density correction controller 89 may also determine a value as a result of dividing, by the variation amount ΔDB (the variation amount ΔWDB₇₀⁰), a difference between the detected toner density WOD₇₀ and the target toner density WOD_{T70} in the case with the duty ratio of 70%. The density correction controller 89 may also determine a value as a result of dividing, by the variation amount ΔDB (the variation amount ΔWDB₁₀₀⁰), a difference between the detected toner density WOD₁₀₀ and the target toner density WOD_{T100} in the case with the duty ratio of 100%. Further, the density correction controller 89 may determine an average value of the above-described three values as the correction amount WDBA of the development voltage WDB.

In the above-described calculation, the variation amount ΔDB may be determined on the basis of the developing unit information table 115 illustrated in FIG. 11 and the development voltage correction table 113 illustrated in FIG. 8. For example, in the developing unit information table 115, the information corresponding to the station ST5 is “W0”, and no developing unit 20 is positioned downstream of the developing unit 20W set to the station ST5. Therefore, the density correction controller 89 may determine the correction amount WDBA by the use of the variation amounts ΔWDB₃₀⁰, ΔWDB₇₀⁰, and ΔWDB₁₀₀⁰ related to the case where the parameter X is 0 (zero) of the variation amounts of the toner density of the toner of white in the development voltage correction table 113.

In a manner similar to that described above, the density correction controller 89 may determine a correction amount KDBA, i.e., the correction amount DBA of the development voltage KDB in the developing unit 20K which is for the color of black by the following expression. The density correction controller 89 may also determine a correction amount CDBA, i.e., the correction amount DBA of the development voltage CDB in the developing unit 20C which is for the color of cyan by the following expression. The density correction controller 89 may determine a correction amount MDBA, i.e., the correction amount DBA of the development voltage MDB in the developing unit 20M which is for the color of magenta by the following expression. The density correction controller 89 may determine a correction amount YDBA, i.e., the correction amount DBA of the development voltage YDB in the developing unit 20Y which is for the color of yellow by the following expression.

KDBA={(KOD₃₀−KOD_{T30})/ΔKDB₃₀¹+(KOD₇₀−KOD_{T70})/ΔKDB₇₀¹+(KOD₁₀₀−KOD_{T100})/ΔKDB₁₀₀¹}/3

CDBA={(COD₃₀−COD_{T30})/ΔCDB₃₀²+(COD₇₀−COD_{T70})/ΔCDB₇₀²+(COD₁₀₀−COD_{T100})/ΔCDB₁₀₀²}/3

MDBA={(MOD₃₀−MOD_{T30})/ΔMDB₃₀³+(MOD₇₀ MOD_{T70})/ΔMDB₇₀³+(MOD₁₀₀−MOD_{T100})/ΔMDB₁₀₀³}/3

YDBA={(YOD₃₀−YOD_{T30})/ΔYDB₃₀⁴+(YOD₇₀−YOD_{T70})/ΔYDB₇₀⁴+(YOD₁₀₀−YOD_{T100})/ΔYDB₁₀₀⁴}/3

That is, in the developing unit information table 115, the information corresponding to the station ST4 is “K1”. Further, the single developing unit 20, i.e., the developing unit 20W, is positioned downstream of the developing unit 20K set to the station ST4 and is set in the down state DN. Therefore, the density correction controller 89 may determine the correction amount KDBA by the use of the variation amounts ΔKDB₃₀¹, ΔKDB₇₀¹, and ΔKDB₁₀₀¹ related to the case where the parameter X is 1 (one), of the variation amounts of the toner density of the toner of black in the development voltage correction table 113. Similarly, in the developing unit information table 115, the information corresponding to the station ST3 is “C2”. Further, the two developing units 20, i.e., the developing units 20K and 20W, are positioned downstream of the developing unit 20C set to the station ST3 and are set in the down state DN. Therefore, the density correction controller 89 may determine the correction amount CDBA by the use of the variation amounts ΔCDB₃₀², ΔCDB₇₀², and ΔCDB₁₀₀² related to the case where the parameter X is 2, of the variation amounts of the toner density of the toner of cyan in the development voltage correction table 113. Similarly, in the developing unit information table 115, the information corresponding to the station ST2 is “M3”. Further, the three developing units 20, i.e., the developing units 20C, 20K, and 20W are positioned downstream of the developing unit 20M set to the station ST2 and are set in the down state DN. Therefore, the density correction controller 89 may determine the correction amount MDBA by the use of the variation amounts ΔMDB₃₀³, ΔMDB₇₀³, and ΔMDB₁₀₀³ related to the case where the parameter X is 3, of the variation amounts of the toner density of the toner of magenta in the development voltage correction table 113. Similarly, in the developing unit information table 115, the information corresponding to the station ST1 is “Y4”. Further, the four developing units 20, i.e., the developing units 20M, 20C, 20K, and 20W are positioned downstream of the developing unit 20Y set to the station ST1 and are set in the down state DN. Therefore, the density correction controller 89 may determine the correction amount YDBA by the use of the variation amounts ΔYDB₃₀⁴, ΔYDB₇₀⁴, and ΔYDB₁₀₀⁴ related to the case where the parameter X is 4, of the variation amounts of the toner density of the toner of yellow in the development voltage correction table 113.

Further, the density correction controller 89 may correct the development voltage DB by the use of the correction amount DBA. For example, the density correction controller 89 may determine, by the use of the following expressions, a corrected development voltage WDB₁ related to the developing unit 20W, a corrected development voltage KDB₁ related to the developing unit 20K, a corrected development voltage CDB₁ related to the developing unit 20C, a corrected development voltage MDB₁ related to the developing unit 20M, and a corrected development voltage YDB₁ related to the developing unit 20Y.

WDB₁=WDB₀+WDBA

KDB₁=KDB₀+KDBA

CDB₁=CDB₀+CDBA

MDB₁=MDB₀+MDBA

YDB₁=YDB₀+YDBA

Thereafter, the image forming apparatus 1 may form the density detection pattern PAT on the transfer surface of the intermediate transfer belt 32 and detect the toner density in the formed density detection pattern PAT (step S125). In step S125, the image forming apparatus 1 may form the density detection pattern PAT by the use of the development voltage DB that has been corrected in step S124. The density detection pattern PAT formed in step S125 may be similar to that formed in step S123. The density sensor 36 may output detected values WV′₃₀, KV′₃₀, CV′₃₀, MV′₃₀, and YV′₃₀ on the basis of the toner images PW30, PK30, PC30, PM30, and PY30, respectively. The density sensor 36 may output detected values WV′₇₀, KV′₇₀, CV′₇₀, MV′₇₀, and YV′₇₀ on the basis of the toner images PW70, PK70, PC70, PM70, and PY70, respectively. The density sensor 36 may output detected values WV′₁₀₀, KV′₁₀₀, MV′₁₀₀, and YV′₁₀₀ on the basis of the toner images PW100, PK100, PC100, PM100, and PY100, respectively.

The density correction controller 89 may convert the detected value V into the toner density OD by the use of the conversion table 111 such as that illustrated in FIG. 6A. The density correction controller 89 may receive the detected value V from the density sensor 36. For example, the density correction controller 89 may determine, by the use of the following expressions: the toner density WOD′₃₀ of the toner of white for the duty ratio of 30%; the toner density WOD′₇₀ of the toner of white for the duty ratio of 70%; and the toner density WOD′₁₀₀ of the toner of white for the duty ratio of 100%.

WOD′₃₀=WA×WV′₃₀+WB

WOD′₇₀=WA×WV′₇₀+WB

WOD′₁₀₀=WA×WV′₁₀₀+WB

This may be similarly applicable to the color of black, cyan, magenta, and yellow.

In an example case where a cubic function is used as illustrated in FIG. 6B, the density correction controller 89 may determine the toner densities KOD′₃₀, KOD′₇₀, and KOD′₁₀₀ of the toner of black by the use of the following expressions.

KOD′₃₀=KD×KV′₃₀³+KC×KV′₃₀²+KA×KV′₃₀+KB

KOD′₇₀=KD×KV′₇₀³+KC×KV′₇₀²+KA×KV′₇₀+KB

KOD′₁₀₀=KD×KV′₁₀₀³+KC×KV′₁₀₀²+KA×KV′₁₀₀+KB

Thereafter, the image forming apparatus 1 may correct the exposure time DK (step S126). First, the density correction controller 89 may determine a correction amount DKA of the exposure time DK on the basis of the toner density OD that has been determined in step S125. The density correction controller 89 may determine the above-described correction amount DKA by the use of the target density table 112 illustrated in FIG. 7, the exposure time correction table 114 illustrated in FIG. 9, and the developing unit information table 115 illustrated in FIG. 11. For example, the density correction controller 89 may determine, by the use of the following expression, a correction amount WDKA, i.e., the correction amount DKA of the exposure time WDK in the developing unit 20W which is for the color of white.

WDKA={(WOD′₃₀−WOD_{T30})/ΔWDK₃₀⁰+(WOD′₇₀−WOD_{T70})/ΔWDK₇₀⁰+(WOD′₁₀₀−WOD_{T100})/ΔWDK₁₀₀⁰}/3

That is, in this example, the density correction controller 89 may determine a value as a result of dividing, by the variation amount ΔDK (the variation amount ΔWDK₃₀⁰), a difference between the detected toner density WOD′₃₀ and the target toner density WOD_{T30} in the case with the duty ratio of 30%. The density correction controller 89 may also determine a value as a result of dividing, by the variation amount ΔDK (the variation amount ΔWDK₇₀⁰), a difference between the detected toner density WOD′₇₀ and the target toner density WOD_{T70} in the case with the duty ratio of 70%. The density correction controller 89 may also determine a value as a result of dividing, by the variation amount ΔDK (the variation amount ΔWDK₁₀₀⁰), a difference between the detected toner density WOD′₁₀₀ and the target toner density WOD_{T100} in the case with the duty ratio of 100%. Further, the density correction controller 89 may determine an average value of the above-described three values as the correction amount DKA of the exposure time DK.

In the above-described calculation, the variation amount ΔDK may be determined on the basis of the developing unit information table 115 illustrated in FIG. 11 and the exposure time correction table 114 illustrated in FIG. 9. For example, in the developing unit information table 115, the information corresponding to the station ST5 is “W0”, and no developing unit 20 is positioned downstream of the developing unit 20W set to the station ST5. Therefore, the density correction controller 89 may determine the correction amount WDKA by the use of the variation amounts WDK₃₀⁰, WDK₇₀⁰, and WDK₁₀₀⁰ related to the case where the parameter X is 0 (zero) of the variation amounts of the toner density of the toner of white in the exposure time correction table 114.

In a manner similar to that described above, the density correction controller 89 may determine a correction amount KDKA, i.e., the correction amount DKA of the exposure time KDK in the developing unit 20K which is for the color of black, by the use of the following expression. The density correction controller 89 may also determine a correction amount CDKA, i.e., the correction amount DKA of the exposure time CDK in the developing unit 20C which is for the color of cyan, by the use of the following expression. The density correction controller 89 may determine a correction amount MDKA, i.e., the correction amount DKA of the exposure time MDK in the developing unit 20M which is for the color of magenta, by the use of the following expression. The density correction controller 89 may determine a correction amount YDKA, i.e., the correction amount DKA of the exposure time YDK in the developing unit 20Y which is for the color of yellow, by the use of the following expression.

KDKA={(KOD′₃₀−KOD_{T30})/ΔKDK₃₀¹+(KOD′₇₀−KOD_{T70})/ΔKDK₇₀¹+(KOD′₁₀₀−KOD_{T100})/ΔKDK₁₀₀¹}/3

CDKA={(COD′₃₀−COD_{T30})/ΔCDK₃₀²+(COD′₇₀−COD_{T70})/ΔCDK₇₀²+(COD′₁₀₀−COD_{T100})/ΔCDK₁₀₀²}/3

MDKA={(MOD′₃₀−MOD_{T30})/ΔMDK₃₀³+(MOD′₇₀ MOD_{T70})ΔMDK₇₀³+(MOD′₁₀₀−MOD_{T100})/ΔMDK₁₀₀³}/3

YDKA={(YOD′₃₀−YOD_{T30})/ΔYDK₃₀⁴+(YOD′₇₀−YOD_{T70})/ΔYDK₇₀⁴+(YOD′₁₀₀−YOD_{T100})/ΔYDK₁₀₀⁴}/3

That is, in the developing unit information table 115, the information corresponding to the station ST4 is “K1”. Further, the single developing unit 20, i.e., the developing unit 20W, is positioned downstream of the developing unit 20K set to the station ST4 and is set in the down state DN. Therefore, the density correction controller 89 may determine the correction amount KDKA by the use of the variation amounts ΔKDK₃₀¹, ΔKDK₇₀¹, and ΔKDK₁₀₀¹ related to the case where the parameter X is 1 (one), of the variation amounts of the toner density of the toner of black in the exposure time correction table 114.

Similarly, in the developing unit information table 115, the information corresponding to the station ST3 is “C2”. Further, the two developing units 20, i.e., the developing units 20K and 20W, are positioned downstream of the developing unit 20C set to the station ST3 and are set in the down state DN. Therefore, the density correction controller 89 may determine the correction amount CDKA by the use of the variation amounts ΔCDK₃₀², ΔCDK₇₀², and ΔCDK₁₀₀² related to the case where the parameter X is 2, of the variation amounts of the toner density of the toner of cyan in the exposure time correction table 114. Similarly, in the developing unit information table 115, the information corresponding to the station ST2 is “M3”. Further, the three developing units 20, i.e., the developing units 20C, 20K, and 20W are positioned downstream of the developing unit 20M set to the station ST2 and are set in the down state DN. Therefore, the density correction controller 89 may determine the correction amount MDKA by the use of the variation amounts ΔMDK₃₀³, ΔMDK₇₀³, and ΔMDK₁₀₀³ related to the case where the parameter X is 3, of the variation amounts of the toner density of the toner of magenta in the exposure time correction table 114. Similarly, in the developing unit information table 115, the information corresponding to the station ST1 is “Y4”. Further, the four developing units 20, i.e., the developing units 20M, 20C, 20K, and 20W are positioned downstream of the developing unit 20Y set to the station ST1 and are set in the down state DN. Therefore, the density correction controller 89 may determine the correction amount YDKA by the use of the variation amounts ΔYDK₃₀⁴, ΔYDK₇₀⁴, and ΔYDK₁₀₀⁴ related to the case where the parameter X is 4, of the variation amounts of the toner density of the toner of yellow in the exposure time correction table 114.

Further, the density correction controller 89 may correct the exposure time DK by the use of the correction amount DKA. For example, the density correction controller 89 may determine, by the use of the following expressions, corrected exposure time WDK₁ related to the developing unit 20W, corrected exposure time KDK₁ related to the developing unit 20K, corrected exposure time CDK₁ related to the developing unit 20C, corrected exposure time MDK₁ related to the developing unit 20M, and corrected exposure time YDK₁ related to the developing unit 20Y.

WDK₁=WDK₀×(1+WDKA)

KDK₁=KDK₀×(1+KDKA)

CDK₁=CDK₀×(1+CDKA)

MDK₁=MDK₀×(1+MDKA)

YDK₁=YDK₀×(1+YDKA)

This may bring the subroutine of the density correction process illustrated in FIG. 13 to an end. This flow may be also brought to an end.

As described above, the density correction process may be performed in the image forming apparatus 1. Therefore, the toner density on the print medium is allowed to be set to an appropriate density. This density correction process may involve correction of the development voltage DB and correction of the exposure time DK. For example, the correction of the development voltage DB may allow for adjustment of the thickness of the toner image to be formed on the developing roller 24. As a result, the toner density may be corrected. Further, the correction of the exposure time DK may allow for adjustment of the exposure energy applied to the photosensitive drum 21. As a result, the toner density, for example, in halftone, may be corrected.

Moreover, in the image forming apparatus 1, the development voltage DB and the exposure time DK related to the developing unit 20 of interest may be corrected on the basis of the number of the development units 20 set operably and positioned downstream of the developing unit 20 of interest. Therefore, the toner density is allowed to be set to an appropriate density.

That is, in a case where the five developing units 20Y, 20M, 20C, 20K, and 20W are set in this order to the stations ST1, ST2, ST3, ST4, and ST5, respectively, and the five developing units 20Y, 20M, 20C, 20K, and 20W are in the down state DN, for example, the black toner image may be formed by the developing unit 20K set to the station ST4 and transferred onto the intermediate transfer belt 32. This black toner image may come into contact with the photosensitive drum 21 of the developing unit 20W positioned downstream of the developing unit 20K, as a result of circular conveyance of the intermediate transfer belt 32 in the conveyance direction F1. On this occasion, the electric charge amount of the black toner image that has been transferred onto the intermediate transfer belt 32 may be varied due to the photosensitive drum 21 of the developing unit 20W. This may possibly vary secondary transfer efficiency, i.e., transfer efficiency at the time of secondary transfer of the toner image from the intermediate transfer belt 32 onto the print medium 9. For example, the toner density of the black toner image formed on the intermediate transfer belt 32 may be the same between the case where the developing unit 20W positioned downstream of the developing unit 20K is in the down state DN (in the operable state) and the case where the developing unit 20W is in the up state UP (in the non-operable state). In contrast, the electric charge amount of the black toner image formed on the intermediate transfer belt 32 may be different between the foregoing two cases. Accordingly, the secondary transfer efficiency may be different between the foregoing two cases. As a result, the toner density on the print medium 9 may possibly involve a difference. This behavior is described below with reference to experiment examples.

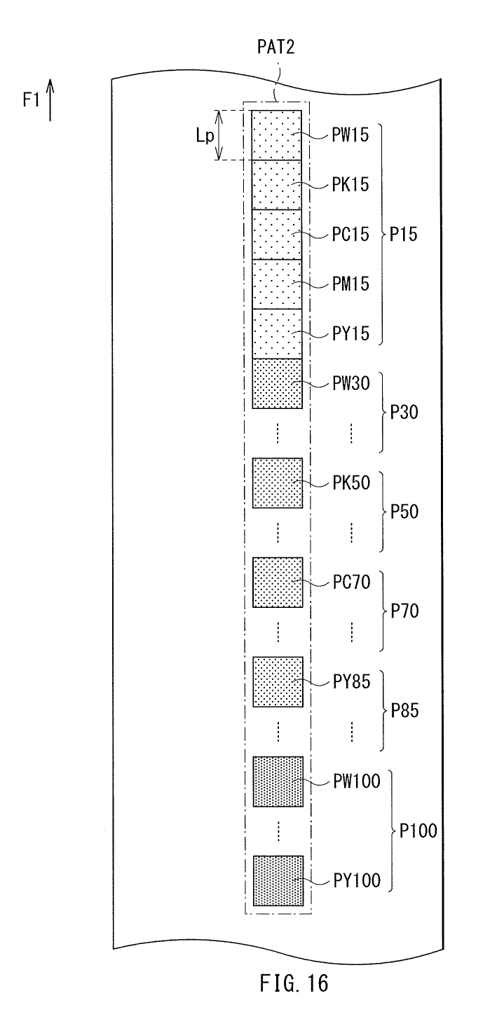

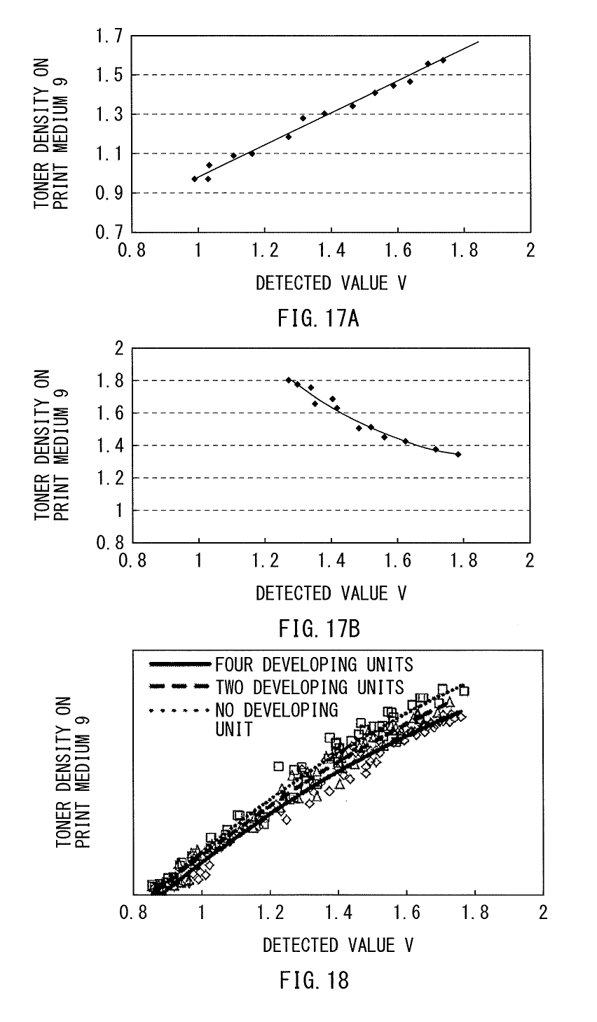

Upon creating the conversion table 111, a lot of experiences may be conducted in advance. The conversion coefficients A and B may be determined on the basis of results of such experiments. For example, a density detection pattern PAT2 illustrated in FIG. 16 may be used in such experiments. The density detection pattern PAT2 may include six patterns, i.e., patterns P15, P30, P50, P70, P85, and P100. The six patterns P15, P30, P50, P70, P85, and P100 may be dither patterns having duty ratios of 15%, 30%, 50%, 70%, 85%, and 100%, respectively. In other words, the density detection pattern PAT2 that is finer than the density detection pattern PAT illustrated in FIG. 14 may be used in the experiments. The image forming apparatus 1 may form the density detection pattern PAT2 on the intermediate transfer belt 32 on the basis of the development voltage DB and the exposure time DK as parameters. Further, the image forming apparatus 1 may cause the density sensor 36 to detect the toner density in the formed density detection pattern PAT2. Further, the image forming apparatus 1 may form the density detection pattern PAT2 on the print medium 9. The toner density of each color in the density detection pattern PAT2 formed on the print medium 9 may be detected by a measuring device different from the image forming apparatus 1. Further, the detected value V obtained by the density sensor 36 and related to one development voltage DB and one exposure time DK may be associated with the toner density on the print medium 9 obtained by the measuring device that are related to the same development voltage DB and the same exposure time DK. FIG. 17A illustrates an example of a result of an experiment using the yellow toner. A result of an experiment using each of the magenta toner, the cyan toner, and the white toner is similar to that illustrated in FIG. 17A. The conversion coefficients A and B may be obtained by approximating the data illustrated in FIG. 17A by a linear function. FIG. 17B illustrates an example of a result of an experiment using the black toner. The conversion coefficients A and B may be obtained by approximating the data illustrated in FIG. 17B by a linear function. The conversion coefficients A to D may be obtained by approximating the data illustrated in FIG. 17B by a cubic function.

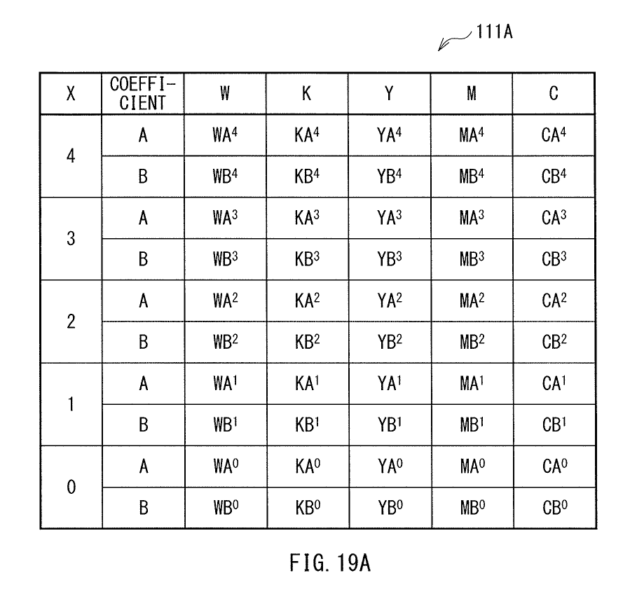

FIG. 18 illustrates a result of an experiment related to the developing unit 20 set to the station ST1 in a case where the developing unit 20 is set to the station ST1 and the number of the operable developing units 20 positioned downstream of the developing unit 20 set to the station ST1 is varied. In this experiment, the number of the operable developing units 20 positioned downstream of the developing unit 20 set to the station ST1 is set to four, two, and zero. As illustrated in FIG. 18, as the number of the operable developing unit 20 positioned downstream of the developing unit 20 set to the station ST1 is increased, the toner density of the toner image on the print medium 9 formed by the developing unit 20 set to the station ST1 is decreased in this example. That is, the electric charge amount of the toner image may be varied due to the developing unit 20 positioned downstream of the developing unit 20 set to the station ST1 between the above-described three cases. Therefore, the secondary transfer efficiency may be different between the above-described three cases. As a result, the toner density on the print medium 9 may involve a difference.

Accordingly, in the image forming apparatus 1, the development voltage DB and the exposure time DK both related to the developing unit 20 of interest may be corrected on the basis of the number of the developing units 20 set operably and positioned downstream of the developing unit 20 of interest. For example, in the image forming apparatus 1, the development voltage correction table 113 illustrated in FIG. 8 may include the information related to the variation amount ΔDB of the toner density at the time when the number of the developing units 20 set operably and positioned downstream of the developing unit 20 of interest is varied, i.e., at the time when the parameter X is varied. Further, the exposure time correction table 114 illustrated in FIG. 9 may include the information related to the variation amount ΔDK of the toner density at the time when the number of the developing units 20 set operably and positioned downstream of the developing unit 20 of interest is varied, i.e., at the time when the parameter X is varied. Accordingly, in the image forming apparatus 1, the development voltage DB and the exposure time DK both related to the developing unit 20 of interest are allowed to be corrected on the basis of the number of the developing unit 20 set operably and positioned downstream of the developing unit 20 of interest. Hence, the toner density is allowed to be set to an appropriate density.

### Example Effects

As described above, according to the first example embodiment, a development voltage and exposure time both related to a developing unit of interest may be corrected on the basis of the number of developing units set operably and positioned downstream of the developing unit of interest. Hence, it is possible to set a toner density to an appropriate density.

### Modification Example 1

In the above-described example embodiment, the development voltage correction table 113 illustrated in FIG. 8 may include the information related to the variation amount ΔDB of the toner density at the time when the number of the developing units 20 set operably and positioned downstream of the developing unit 20 of interest is varied, i.e., at the time when the parameter X is varied. Further, the exposure time correction table 114 illustrated in FIG. 9 may include the information related to the variation amount ΔDK of the toner density at the time when the number of the developing units 20 set operably and positioned downstream of the developing unit 20 of interest is varied, i.e., at the time when the parameter X is varied. However, this is non-limiting. In another example embodiment, for example, the conversion table may include the information related to the conversion coefficients A and B at the time when the number of the developing units 20 set operably and positioned downstream of the developing unit 20 of interest is varied, i.e., at the time when the parameter X is varied. A detailed description is provided below of an image forming apparatus 1A according to Modification example 1.

As illustrated in FIG. 5, the image forming apparatus 1A may include storage 67A and a controller 88A. The storage 67A may hold density correction information 110A. The density correction information 110A may include a conversion table 111A, the target density table 112, a development voltage correction table 113A, and an exposure time correction table 114A.

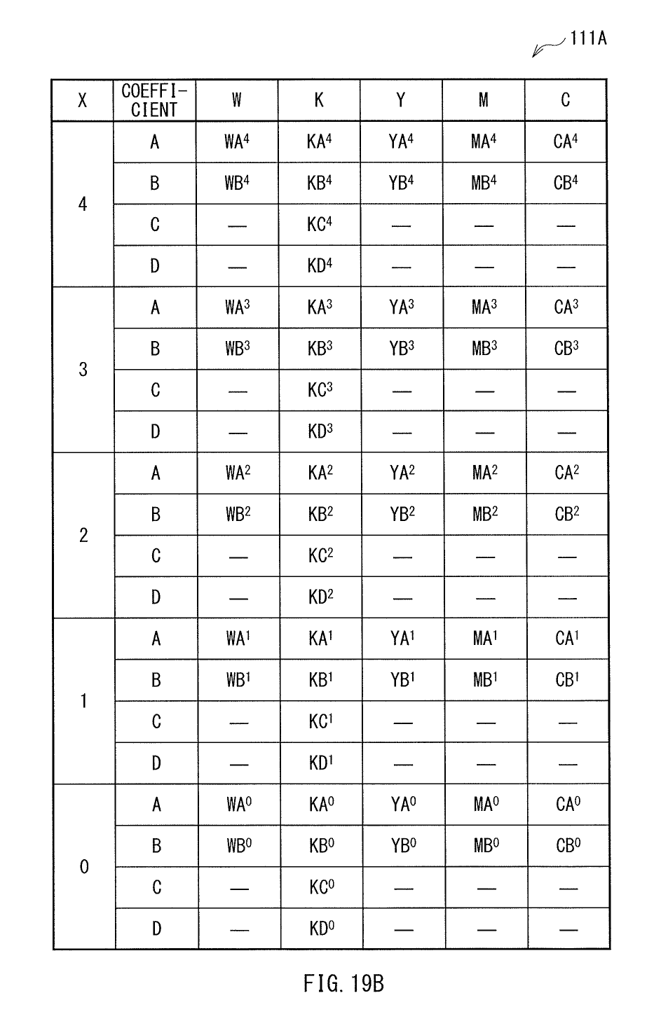

FIG. 19A illustrates an example of a configuration of the conversion table 111A. The conversion table 111A may include: conversion coefficients WA^{X} and WB^{X} both related to the toner of white (W); conversion coefficients KA^{X} and KB^{X} both related to the toner of black (K); conversion coefficients YA^{X} and YB^{X} both related to the toner of yellow (Y); conversion coefficients MA^{X} and MB^{X} both related to the toner of magenta (M); and conversion coefficients CA^{X} and CB^{X} both related to the toner of cyan (C).

FIG. 19B illustrates another example of the configuration of the conversion table 111A. This conversion table 111A may include conversion coefficients KA^{X}, KB^{X}, KC^{X}, and KD^{X} all related to the toner of black (K).

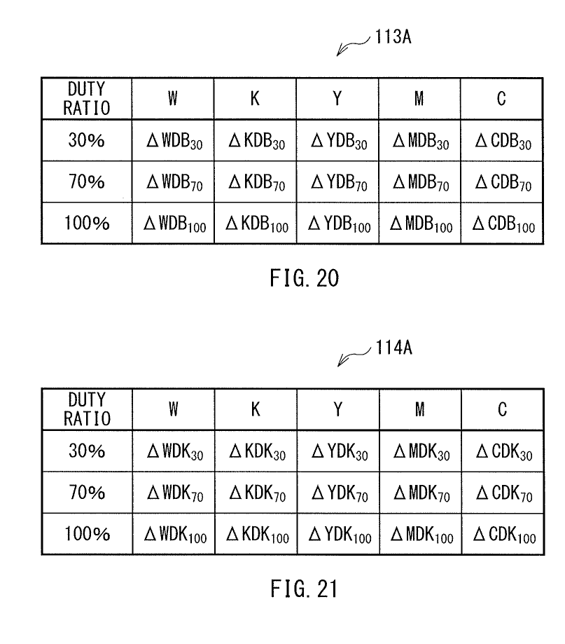

FIG. 20 illustrates an example of a configuration of the development voltage correction table 113A. The development voltage correction table 113A may include a variation amount ΔDB₃₀ of the toner density for the duty ratio of 30%, a variation amount ΔDB₇₀ of the toner density for the duty ratio of 70%, and a variation amount ΔDB₁₀₀ of the toner density for the duty ratio of 100%, for the toner of each color.

FIG. 21 illustrates an example of a configuration of the exposure time correction table 114A. The exposure time correction table 114A may include a variation amount ΔDK₃₀ of the toner density for the duty ratio of 30%, a variation amount ΔDK₇₀ of the toner density for the duty ratio of 70%, and a variation amount ΔDK₁₀₀ of the toner density for the duty ratio of 100%, for the toner of each color.

The controller 88A may include a density correction controller 89A. The density correction controller 89A may control the density correction process in the image forming apparatus 1A.

A description is given below of an example of the density correction process illustrated in FIG. 13 performed by the image forming apparatus 1A referring to an example case where: the five developing units 20Y, 20M, 20C, 20K, and 20W are set in this order to the stations ST1, ST2, ST3, ST4, and ST5, respectively; and the five developing units 20Y, 20M, 20C, 20K, and 20W are in the down state DN.

First, the density correction controller 89A may set each of a development voltage DB and exposure time DK to a predetermined initial value (step S121). In other words, in step S121, the density correction controller 89A may set the development voltage DB to a development voltage DB₀ and set the exposure time DK to exposure time DK₀.

Thereafter, the density correction controller 89A may read the density correction information 110A stored in the storage 67A (step S122).

Thereafter, the image forming apparatus 1A may form the density detection pattern PAT on the transfer surface of the intermediate transfer belt 32 and detect the toner density in the density detection pattern PAT (step S133). The density correction controller 89A may convert the detected value V into the toner density OD by the use of the developing unit information table 115 illustrated in FIG. 11 and the conversion table 111A such as that illustrated in FIG. 19A. The density correction controller 89A may receive the foregoing detected value V from the density sensor 36. For example, the density correction controller 89A may determine, by the use of the following expressions: the toner density WOD₃₀ of the toner of white for the duty ratio of 30%; the toner density WOD₇₀ of the toner of white for the duty ratio of 70%; and the toner density WOD₁₀₀ of the toner of white for the duty ratio of 100%.

WOD₃₀=WA⁰×WV₃₀+WB⁰

WOD₇₀=WA⁰×WV₇₀+WB⁰

WOD₁₀₀=WA⁰×WV₁₀₀+WB⁰

That is, in the developing unit information table 115, the information corresponding to the station ST5 is “W0”, and no developing unit 20 is positioned downstream of the developing unit 20W set to the station ST5. Therefore, the density correction controller 89A may determine the toner densities WOD₃₀, WOD₇₀, and WOD₁₀₀ by the use of the conversion coefficients WA⁰ and WB⁰ related to the case where the parameter X is 0 (zero) of the conversion coefficients of the toner of white in the conversion table 111A.

In a manner similar to that described above, the density correction controller 89A may determine: the toner densities KOD₃₀, KOD₇₀, and KOD₁₀₀ of the toner of black; the toner densities COD₃₀, COD₇₀, and COD₁₀₀ of the toner of cyan; toner densities MOD₃₀, MOD₇₀, and MOD₁₀₀ of the toner of magenta; and toner densities YOD₃₀, YOD₇₀, and YOD₁₀₀ of the toner of yellow.

KOD₃₀=KA′×KV₃₀+KB¹

KOD₇₀=KA′×KV₇₀+KB¹

KOD₁₀₀=KA′×KV₁₀₀+KB¹

COD₃₀=CA²×CV₃₀+CB²

COD₇₀=CA²×CV₇₀+CB²

COD₁₀₀=CA²×CV₁₀₀+CB²

MOD₃₀=MA³×MV₃₀+MB³

MOD₇₀=MA³×MV₇₀+MB³

MOD₁₀₀=MA³×MV₁₀₀+MB³

YOD₃₀=YA⁴×YV₃₀+YB⁴

YOD₇₀=YA⁴×YV₇₀+YB⁴

YOD₁₀₀=YA⁴×YV₁₀₀+YB⁴

That is, in the developing unit information table 115, the information corresponding to the station ST4 is “K1”. Further, the single developing unit 20, i.e., the developing unit 20W, is positioned downstream of the developing unit 20K set to the station ST4 and is set in the down state DN. Therefore, the density correction controller 89A may determine the toner densities KOD₃₀, KOD₇₀, and KOD₁₀₀ by the use of the conversion coefficients KA′ and KB′ related to the case where the parameter X is 1 (one), of the conversion coefficients of the toner of black in the conversion table 111A. Similarly, in the developing unit information table 115, the information corresponding to the station ST3 is “C2”. Further, the two developing units 20, i.e., the developing units 20K and 20W, are positioned downstream of the developing unit 20C set to the station ST3 and are set in the down state DN. Therefore, the density correction controller 89A may determine the toner densities COD₃₀, COD₇₀, and COD₁₀₀ by the use of the conversion coefficients CA² and CB² related to the case where the parameter X is 2, of the conversion coefficients of the toner of cyan in the conversion table 111A. Similarly, in the developing unit information table 115, the information corresponding to the station ST2 is “M3”. Further, the three developing units 20, i.e., the developing units 20C, 20K, and 20W are positioned downstream of the developing unit 20M set to the station ST2 and are set in the down state DN. Therefore, the density correction controller 89A may determine the toner densities MOD₃₀, MOD₇₀, and MOD₁₀₀ by the use of the conversion coefficients MA³ and MB³ related to the case where the parameter X is 3, of the conversion coefficients of the toner of magenta in the conversion table 111A. Similarly, in the developing unit information table 115, the information corresponding to the station ST1 is “Y4”. Further, the four developing units 20, i.e., the developing units 20M, 20C, 20K, and 20W are positioned downstream of the developing unit 20Y set to the station ST1 and are set in the down state DN. Therefore, the density correction controller 89A may determine the toner densities YOD₃₀, YOD₇₀, and YOD₁₀₀ by the use of the conversion coefficients YA⁴ and YB⁴ related to the case where the parameter X is 4, of the conversion coefficients of the toner of yellow in the conversion table 111A.

Thereafter, the image forming apparatus 1A may correct the development voltage DB (step S134). First, the density correction controller 89A may determine the correction amount DBA of the development voltage DB on the basis of the toner density OD that has been determined in step S133. The density correction controller 89A may determine the above-described correction amount DBA by the use of the target density table 112 illustrated in FIG. 7 and the development voltage correction table 113A illustrated in FIG. 20. For example, the density correction controller 89A may determine, by the use of the following expression, the correction amount WDBA of the development voltage WDB in the developing unit 20W which is for the color of white.

WDBA={(WOD₃₀−WOD_{T30})/ΔWDB₃₀+(WOD₇₀−WOD_{T70})/ΔWDB₇₀+(WOD₁₀₀−WOD_{T100})/ΔWDB₁₀₀}/3

This may be similarly applicable to each of the colors of black, cyan, magenta, and yellow. Further, the density correction controller 89A may correct the development voltage DB by the use of the determined correction amount DBA.

Thereafter, the image forming apparatus 1A may form the density detection pattern PAT on the transfer surface of the intermediate transfer belt 32 and detect the toner density in the formed density detection pattern PAT (step S135). In step S135, the image forming apparatus 1A may form the foregoing density detection pattern PAT by the use of the development voltage DB that has been corrected in step S134. The density correction controller 89A may convert the detected value V into the toner density OD by the use of the developing unit information table 115 illustrated in FIG. 11 and the conversion table 111A such as that illustrated in FIG. 19A. The density correction controller 89A may receive the foregoing detected value V from the density sensor 36. For example, the density correction controller 89A may determine, by the use of the following expressions: the toner densities WOD′₃₀, WOD′₇₀, and WOD′₁₀₀ of the toner of white; the toner densities KOD′₃₀, KOD′₇₀, and KOD′₁₀₀ of the toner of black; the toner densities COD′₃₀, COD′₇₀, and COD′₁₀₀ of the toner of cyan; the toner densities MOD′₃₀, MOD′₇₀, and MOD′₁₀₀ of the toner of magenta; and the toner densities YOD′₃₀, YOD′₇₀, and YOD′₁₀₀ of the toner of yellow. The calculations in step S134 may be similar to those in step S133.

WOD′₃₀=WA⁰×WV′₃₀+WB⁰

WOD′₇₀=WA⁰×WV′₇₀+WB⁰

WOD′₁₀₀=WA⁰×WV′₁₀₀+WB⁰

KOD′₃₀=KA′×KV′₃₀+KB

KOD′₇₀=KA′×KV′₇₀+KB¹

KOD′₁₀₀=KA′×KV₁₀₀+KB¹

COD′₃₀=CA²×CV′₃₀+CB²

COD′₇₀=CA²×CV′₇₀+CB²

COD′₁₀₀=CA²×CV′₁₀₀+CB²

MOD′₃₀=MA³×MV′₃₀+MB³

MOD′₇₀=MA³×MV′₇₀+MB³

MOD′₁₀₀=MA³×MV′₁₀₀+MB³

YOD′₃₀=YA⁴×YV′₃₀+YB⁴

YOD′₇₀=YA⁴×YV′₇₀+YB⁴

YOD′₁₀₀=YA⁴×YV′₁₀₀+YB⁴

Thereafter, the image forming apparatus 1A may correct the exposure time DK (step S136). First, the density correction controller 89A may determine the correction amount DKA of the exposure time DK on the basis of the toner density OD that has been determined in step S135. The density correction controller 89A may determine the foregoing correction amount DKA by the use of the target density table 112 illustrated in FIG. 7 and the exposure time correction table 114A illustrated in FIG. 21. For example, the density correction controller 89A may determine the correction amount WDKA of the exposure time WDK in the developing unit 20W which is for the color of white.

WDKA={(WOD′₃₀−WOD_{T30})/ΔWDK₃₀⁰+(WOD′₇₀−WOD_{T70})/ΔWDK₇₀⁰+(WOD′₁₀₀−WOD_{T100})/ΔWDK₁₀₀⁰}/3

This may be similarly applicable to each of the colors of black, cyan, magenta, and yellow. Further, the density correction controller 89A may correct the exposure time DK by the use of the determined correction amount DKA.

### 2. SECOND EXAMPLE EMBODIMENT

A description is given next of an image forming apparatus 2 according to a second example embodiment of the technology. According to the second example embodiment, the development voltage and the exposure time both related to the developing unit of interest may be corrected not only on the basis of the number of developing units set operably and positioned downstream of the developing unit of interest but also on the basis of the color of the developing unit set operably and positioned downstream of the developing unit of interest. It is to be noted that components substantially the same as those in the image forming apparatus 1 according to the first example embodiment described above may be denoted with the same numerals, and will not be described further where appropriate.

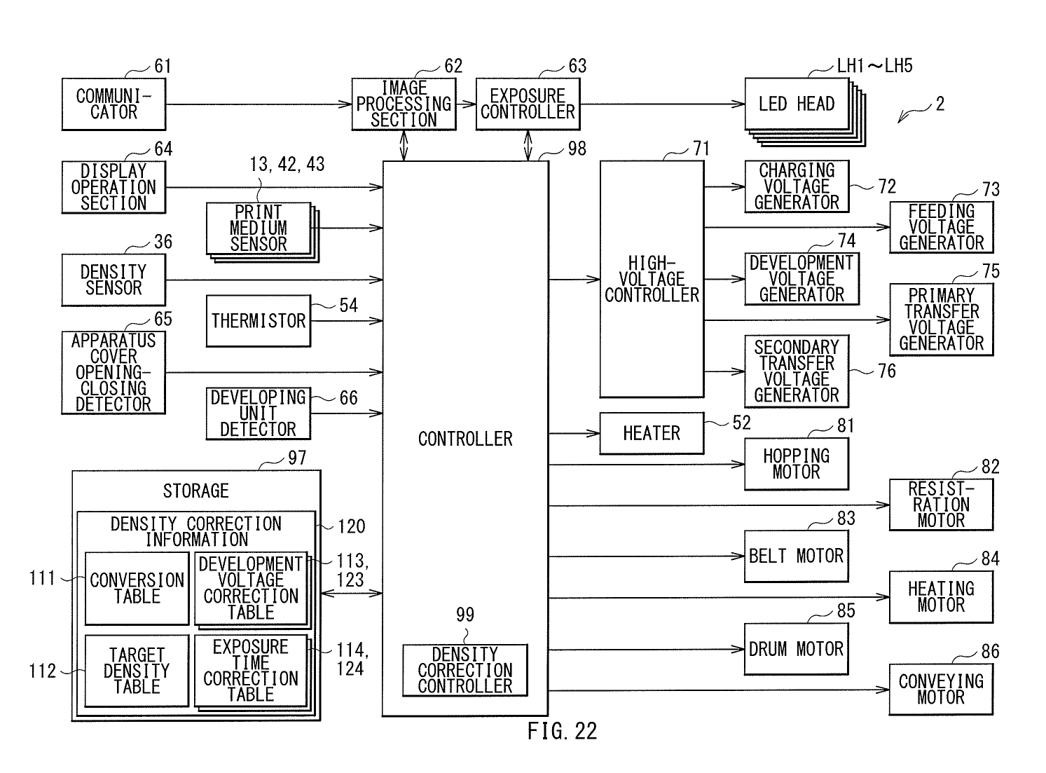

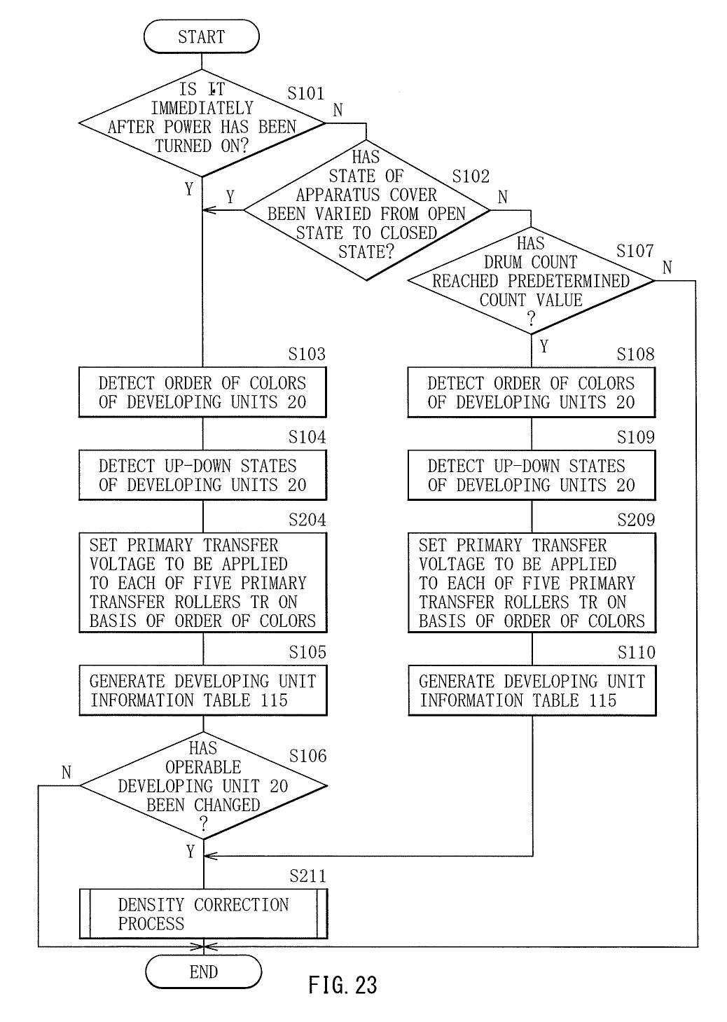

FIG. 22 illustrates an example of a configuration of an image forming apparatus 2. The image forming apparatus 2 may include storage 97 and a controller 98. The storage 97 may hold density correction information 120. The density correction information 120 may include two development voltage correction tables, i.e., the development voltage correction table 113 and a development voltage correction table 123, and two exposure time correction tables, i.e., the exposure time correction table 114 and an exposure time correction table 124.

Each of the development voltage correction tables 113 and 123 may include information related to the variation amount ΔDB of the toner density in a case where the development voltage is varied by 1 (one) [V]. The development voltage correction table 113 may include the information related to the variation amount ΔDB of the toner density in a case where the developing unit 20W for white is set operably and positioned downstream of the developing unit 20 of interest. The development voltage correction table 123 may include the information related to the variation amount ΔDB of the toner density in a case where the developing unit 20K for black is set operably and positioned downstream of the developing unit 20 of interest. The development voltage correction table 123 may have a configuration similar to that of the development voltage correction table 113 illustrated in FIG. 8.

Each of the exposure time correction tables 114 and 124 may include information related to the variation amount ΔDK of the toner density in a case where the exposure time is varied by 1 (one) [%]. The exposure time correction table 114 may include the information related to the variation amount ΔDK of the toner density in a case where the developing unit 20W for white is set operably and positioned downstream of the developing unit 20 of interest. The exposure time correction table 124 may include the information related to the variation amount ΔDK of the toner density in a case where the developing unit 20K for black is set operably and positioned downstream of the developing unit 20 of interest. The exposure time correction table 124 may have a configuration similar to that of the exposure time correction table 114 illustrated in FIG. 9. The controller 98 may include a density correction controller 99. The density correction controller 99 may control the density correction process in the image forming apparatus 2.

FIG. 23 illustrates an example of operation of the image forming apparatus 2.

First, the image forming apparatus 2 may confirm whether it is immediately after the power has been turned on (step S101). When it is immediately after the power has been turned on (“Y” in step S101), the flow may proceed to step S103.

When it is not immediately after the power has been turned on in step S101 (“N” in step S101), the apparatus cover opening-closing detector 65 may confirm whether the state of the apparatus cover has been varied from an open state to a closed state (step S102). When the state of the apparatus cover has been varied from the open state to the closed state (“Y” in step S102), the flow may proceed to step S103. When the state of the apparatus cover has not been varied from the open state to the closed state (“N” in step S102), the flow may proceed to step S107.

Thereafter, the developing unit detector 66 may detect the order of the colors of the developing units 20 set to the respective stations ST1 to ST5 (step S103). Thereafter, the developing unit detector 66 may detect the up-down state of each of the developing units 20 (step S104).

Thereafter, the controller 98 may set the primary transfer voltage to be applied to each of the five primary transfer rollers TR on the basis of the order of the colors that has been detected in step S103 (step S204).

Thereafter, the density correction controller 99 may generate the developing unit information table 115 on the basis of results of the detections performed in respective steps S103 and S104 (step S105).

Thereafter, the density correction controller 99 may confirm whether any of the one or more operable developing units 20 in the stations ST1 to ST5 has been changed (step S106). The density correction controller 99 may perform such confirmation on the basis of the developing unit information table 115 that has been generated in step S105. When any of the one or more operable developing units 20 has not been changed (“N” in step S106), the flow may be brought to an end. Alternatively, when any of the one or more operable developing units 20 has been changed (“Y” in step S106), the flow may proceed to step S211.

When the state of the apparatus cover has not been varied from the open state to the closed state in step S102 (“N” in step S102), the density correction controller 99 may confirm whether the drum count has reached the predetermined count value (step S107). The drum count may indicate the accumulated rotation number of the photosensitive drum 21 in each of the developing units 20. When the drum count has not reached the predetermined count value (“N” in step S107), the flow may be brought to the end.

When the drum count has reached the predetermined count value in step S107 (“Y” in step S107), in manners similar to those in steps S103 to S105, the developing unit detector 66 may detect the order of the colors of the developing units 20 in the respective stations ST1 to ST5 (step S108), the developing unit detector 66 may detect the up-down state of each of the developing units 20 (step S109), the controller 98 may set the primary transfer voltage to be applied to each of the five primary transfer rollers TR on the basis of the order of colors that has been detected in step S108 (step S209), and the density correction controller 99 may generate the developing unit information table 115 on the basis of results of detections performed in respective steps S108 and S109 (step S110). Thereafter, the flow may proceed to step S211.

In step S211, the density correction controller 99 may perform the density correction process (step S211).

As illustrated in FIG. 13, first, the density correction controller 99 may set each of a development voltage DB and exposure time DK to a predetermined initial value (step S121). In other words, in step S121, the density correction controller 99 may set the development voltage DB to a development voltage DB₀ and set the exposure time DK to exposure time DK₀. Thereafter, the density correction controller 99 may read the density correction information 120 stored in the storage 97 (step S122). Thereafter, the image forming apparatus 2 may form the density detection pattern PAT on the transfer surface of the intermediate transfer belt 32 and detect the toner density in the density detection pattern PAT formed on the intermediate transfer belt 32 (step S123).

Thereafter, the image forming apparatus 2 may correct the development voltage DB (step S224). First, the density correction controller 99 may determine the correction amount DBA of the development voltage DB on the basis of the toner density OD that has been determined in step S123. The density correction controller 99 may determine the foregoing correction amount DBA of the development voltage DB by the use of the target density table 112 illustrated in FIG. 7, the development voltage correction table 113 illustrated in FIG. 8, the development voltage correction table 123, and the developing unit information table 115 illustrated in FIG. 11. On this occasion, the density correction controller 99 may use the development voltage correction table 113 to determine the correction amount DBA related to any of the developing units 20Y, 20M, and 20C in a case where the developing unit 20W is set operably and positioned downstream of the one of interest of the developing units 20Y, 20M, and 20C. The density correction controller 99 may use the development voltage correction table 123 to determine the correction amount DBA related to any of the developing units 20Y, 20M, and 20C in a case where the developing unit 20K is set operably and positioned downstream of the one of interest of the developing units 20Y, 20M, and 20C. Further, the density correction controller 99 may correct the development voltage DB by the use of the determined correction amount DBA.

Thereafter, the image forming apparatus 2 may form the density detection pattern PAT on the transfer surface of the intermediate transfer belt 32 and detect the toner density of the formed density detection pattern PAT (step S125). In step S125, the image forming apparatus 2 may form the density detection pattern PAT by the use of the development voltage DB that has been corrected in step S224.

Thereafter, the image forming apparatus 2 may correct the exposure time DK (step S226). First, the density correction controller 99 may determine the correction amount DKA of the exposure time DK on the basis of the toner density OD that has been determined in step S125. The density correction controller 99 may determine the above-described correction amount DKA by the use of the target density table 112 illustrated in FIG. 7, the exposure time correction table 114 illustrated in FIG. 9, the exposure time correction table 124, and the developing unit information table 115 illustrated in FIG. 11. On this occasion, the density correction controller 99 may use the exposure time correction table 114 to determine the correction amount DKA related to any of the developing units 20Y, 20M, and 20C in a case where the developing unit 20W is set operably and positioned downstream of the one of interest of the developing units 20Y, 20M, and 20C. The density correction controller 99 may use the exposure time correction table 124 to determine the correction amount DKA related to any of the developing units 20Y, 20M, and 20C in a case where the developing unit 20K is set operably and positioned downstream of the one of interest of the developing units 20Y, 20M, and 20C. Further, the density correction controller 99 may correct the exposure time DK by the use of the determined correction amount DKA.

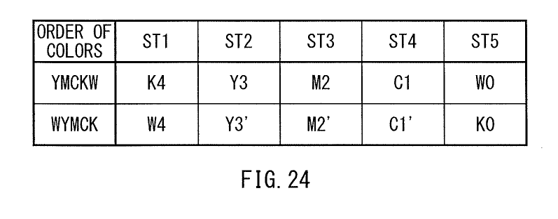

FIG. 24 schematically illustrates an example of operation of the density correction controller 99. For example, in a case where the order of the colors is “KYMCW”, the developing unit 20W is set operably and positioned downstream of the developing units 20Y, 20M, and 20C. Therefore, the density correction controller 99 may correct the development voltage DB by the use of the development voltage correction table 113 of the two development voltage correction tables, i.e., the development voltage correction tables 113 and 123. Further, the density correction controller 99 may correct the exposure time DK by the use of the exposure time correction table 114 of the two exposure time correction tables, i.e., the exposure time correction tables 114 and 124. In another example, in a case where the order of the colors is “WYMCK”, the developing unit 20K is set operably and positioned downstream of the developing units 20Y, 20M, and 20C. Therefore, the density correction controller 99 may correct the development voltage DB by the use of the development voltage correction table 123 of the two development voltage correction tables, i.e., the development voltage correction tables 113 and 123. Further, the density correction controller 99 may correct the exposure time DK by the use of the exposure time correction table 124 of the two development voltage correction tables, i.e., the exposure time correction tables 114 and 124.

As described above, the development voltage DB and the exposure time DK both related to the developing unit 20 of interest may be corrected on the basis of the color of the development unit 20 set operably and positioned downstream of the developing unit 20 of interest. Therefore, the toner density is allowed to be set to an appropriate density.

That is, for example, the toner image may be formed by the developing unit 20C set to the station ST4 and transferred onto the intermediate transfer belt 32.

This toner image may come into contact with the primary transfer roller TR5 positioned downstream of the developing unit 20C, as a result of circular conveyance of the intermediate transfer belt 32 in the conveyance direction F1. For example, the primary transfer voltage to be applied to the primary transfer roller TR5 corresponding to the station ST5 may be different between a case where the developing unit 20W that forms the white toner image is set to the station ST5 and a case where the developing unit 20K that forms the black toner image is set to the station ST5. For example, the electric charge amount of the cyan toner image transferred onto the intermediate transfer belt 32 may be influenced by the primary transfer voltage applied to the primary transfer roller TR5 positioned downstream of the developing unit 20C. Accordingly, the transfer efficiency (the secondary transfer efficiency) at the time when the cyan toner image is subjected to secondary transfer from the intermediate transfer belt 32 onto the print medium 9 may be possibly different between a case where the developing unit 20W is set to the station ST5 and a case where the developing unit 20K is set to the station ST5. As a result, the toner density on the print medium 9 may possibly involve a difference.

Accordingly, in the image forming apparatus 2, each of the development voltage DB and the exposure time DK both related to the developing unit 20 of interest may be corrected on the basis of the color of the developing unit 20 set operably and positioned downstream of the developing unit 20 of interest. For example, in the image forming apparatus 2, the development voltage correction table 113 and the exposure time correction table 114 may be selected in a case where the developing unit 20W is set operably and positioned downstream of the developing unit 20 of interest. Further, the development voltage correction table 123 and the exposure time correction table 124 may be selected in a case where the developing unit 20K is set operably and positioned downstream of the developing unit 20 of interest. Accordingly, in the image forming apparatus 2, the development voltage DB and the exposure time DK both related to the developing unit 20 of interest are allowed to be corrected on the basis of the color of the developing unit 20 that is set operably and positioned downstream of the developing unit 20 of interest. Hence, the toner density is allowed to be set to an appropriate density.

### Example Effects

As described above, according to the second example embodiment, a development voltage and exposure time both related to a developing unit of interest may be corrected on the basis of a color of a developing unit that is set operably and positioned downstream of the developing unit of interest. Hence, it is possible to set a toner density to an appropriate density.

The technology has been described above referring to the example embodiments and the modification examples thereof. However, the technology is not limited to the example embodiments and the modification examples described above, and is modifiable in various ways.

For example, in the example embodiments and the modification examples described above, five stations ST may be provided, thereby allowing five developing units 20 to be set. However, this is non-limiting. The number of the provided stations ST may be any plural number.

In the example embodiments and the modification examples described above, the white toner may be used. However, this is non-limiting. In one example, a toner of any color other than white may be used instead of the white toner. Non-limiting examples of the toner of any color other than white may include a transparent toner, i.e., a clear toner.

For example, the example embodiments and the modification examples described above may each be applied to a single-function printer. However, this is non-limiting. Alternatively, any embodiment of the technology may be applied to a so-called multi-function peripheral having functions such as a copy function, a facsimile function, a scanning function, or a printing function.

Furthermore, the technology encompasses any possible combination of some or all of the various embodiments and the modifications described herein and incorporated herein. It is possible to achieve at least the following configurations from the above-described example embodiments of the technology.

(1)

An image forming apparatus including;

one or more developing units including a first developing unit and each operably set to corresponding one of a plurality of stations, the one or more developing units each including a photosensitive member and a developing member, the developing member forming a developer image by developing, with a developer, an electrostatic latent image formed on the photosensitive member;

a detector that performs a detection of the one or more developing units;

a voltage application unit that applies a development voltage to the developing member of each of the one or more developing units;

one or more exposure units that each perform exposure of the photosensitive member of corresponding one of the one or more developing units;

an image conveying member that conveys the developer image along a path that passes through the plurality of stations;

one or more primary transfer members that each transfer, onto the image conveying member, the developer image formed on the photosensitive member of corresponding one of the one or more developing units;

a sensor that performs a detection of an amount of the developer present on the image conveying member; and

a setting unit that acquires developing unit information on the basis of a result of the detection performed by the detector, and sets a first-developing-unit development voltage, first-developing-unit exposure energy, or both on the basis of a result of the detection performed by the sensor and information, the information being included in the developing unit information and related to one or more downstream stations, the developing unit information being information related to the one or more developing units each operably set to the corresponding one of the plurality of stations, the one or more downstream stations being one or more, of the plurality of stations, positioned downstream, in a direction of conveyance performed by the image conveying member, of one of the plurality of stations to which the first developing unit is set, the first-developing-unit development voltage being the development voltage to be applied to the developing member of the first developing unit, the first-developing-unit exposure energy being exposure energy in one, of the one or more exposure units, which corresponds to the first developing unit.

(2)

The image forming apparatus according to (1), further including a secondary transfer member that transfers, onto a print medium, the developer image that has been transferred onto the image conveying member.

(3)

The image forming apparatus according to (1) or (2), in which the developing unit information includes information related to a downstream developing unit number, the downstream developing unit number indicating how many of the one or more developing units are operably set to the one or more downstream stations.

(4)

The image forming apparatus according to (3), in which the setting unit sets the first-developing-unit development voltage to a first voltage when the downstream developing unit number is a first number, and the setting unit sets the first-developing-unit development voltage to a second voltage when the downstream developing unit number is a second number.

(5)

The image forming apparatus according to (3) or (4), in which the setting unit sets the first-developing-unit exposure energy to first energy when the downstream developing unit number is a first number, and the setting unit sets the first-developing-unit exposure energy to second energy when the downstream developing unit number is a second number.

(6)

The image forming apparatus according to any one of (1) to (5), in which the one or more developing units include a plurality of developing units that form the respective developer images with respective developers of respective colors different from each other, the plurality of developing units includes a second developing unit operably set to one of the one or more downstream stations, and the developing unit information includes information related to a color of the developer to be used in the second developing unit.

(7)

The image forming apparatus according to (6), in which the setting unit sets the first-developing-unit development voltage to a first voltage when the color of the developer to be used in the second developing unit is a first color, and the setting unit sets the first-developing-unit development voltage to a second voltage when the color of the developer to be used in the second developing unit is a second color.

(8)

The image forming apparatus according to (6) or (7), in which the setting unit sets the first-developing-unit exposure energy to first energy when the color of the developer to be used in the second developing unit is a first color, and the setting unit sets the first-developing-unit exposure energy to second energy when the color of the developer to be used in the second developing unit is a second color.

(9)

The image forming apparatus according to any one of (6) to (8), in which the one or more primary transfer members include a plurality of primary transfer members corresponding to the respective plurality of developing units, and the voltage application unit further applies a transfer voltage to one, of the plurality of primary transfer members, corresponding to the second developing unit, the transfer voltage being a voltage corresponding to the color of the developer to be used in the second developing unit.

(10)

The image forming apparatus according to any one of (1) to (9), in which the setting unit sets the first-developing-unit development voltage, the first-developing-unit exposure energy, or both when any of the one or more developing units each operably set to the corresponding one of the plurality of stations is changed.

(11)

The image forming apparatus according to any one of (1) to (10), in which the one or more developing units include a basic-color developing unit and an auxiliary-color developing unit, the basic-color developing unit forming the developer image with a basic-color developer, the auxiliary-color developing unit forming the developer image with an auxiliary-color developer.

(12)

The image forming apparatus according to (11), in which the auxiliary-color developer includes a white developer.

(13)

The image forming apparatus according to (11), in which the auxiliary-color developer includes a transparent developer.

(14)

The image forming apparatus according to any one of (11) to (13), in which the auxiliary-color developing unit is operably set to one, of the plurality of stations, positioned most upstream in the direction of the conveyance performed by the image conveying member.

(15)

The image forming apparatus according to any one of (11) to (13), in which the auxiliary-color developing unit is operably set to one, of the plurality of stations, positioned most downstream in the direction of the conveyance performed by the image conveying member.

(16)

The image forming apparatus according to any one of (1) to (15), in which the first developing unit is settable to any of the plurality of stations.

According to the image forming apparatus according to one embodiment of the technology, the development voltage to be applied to the developing member of the first developing unit, the exposure energy in the exposure unit corresponding to the first developing unit, or both are set on the basis of the information related to the one or more stations positioned downstream of the station to which the first developing unit is set. Hence, it is possible to set a density of the developer on the print medium to an appropriate density.

Although the technology has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. An image forming apparatus comprising;
one or more developing units including a first developing unit and each operably set to corresponding one of a plurality of stations, the one or more developing units each including a photosensitive member and a developing member, the developing member forming a developer image by developing, with a developer, an electrostatic latent image formed on the photosensitive member;
a detector that performs a detection of the one or more developing units;
a voltage application unit that applies a development voltage to the developing member of each of the one or more developing units;
one or more exposure units that each perform exposure of the photosensitive member of corresponding one of the one or more developing units;
an image conveying member that conveys the developer image along a path that passes through the plurality of stations;
one or more primary transfer members that each transfer, onto the image conveying member, the developer image formed on the photosensitive member of corresponding one of the one or more developing units;
a sensor that performs a detection of an amount of the developer present on the image conveying member; and
a setting unit that acquires developing unit information on a basis of a result of the detection performed by the detector, and sets a first-developing-unit development voltage, first-developing-unit exposure energy, or both on a basis of a result of the detection performed by the sensor and information, the information being included in the developing unit information and related to one or more downstream stations, the developing unit information being information related to the one or more developing units each operably set to the corresponding one of the plurality of stations, the one or more downstream stations being one or more, of the plurality of stations, positioned downstream, in a direction of conveyance performed by the image conveying member, of one of the plurality of stations to which the first developing unit is set, the first-developing-unit development voltage being the development voltage to be applied to the developing member of the first developing unit, the first-developing-unit exposure energy being exposure energy in one, of the one or more exposure units, which corresponds to the first developing unit.

2. The image forming apparatus according to claim 1, further comprising a secondary transfer member that transfers, onto a print medium, the developer image that has been transferred onto the image conveying member.

3. The image forming apparatus according to claim 1, wherein the developing unit information includes information related to a downstream developing unit number, the downstream developing unit number indicating how many of the one or more developing units are operably set to the one or more downstream stations.

4. The image forming apparatus according to claim 3, wherein
the setting unit sets the first-developing-unit development voltage to a first voltage when the downstream developing unit number is a first number, and
the setting unit sets the first-developing-unit development voltage to a second voltage when the downstream developing unit number is a second number.

5. The image forming apparatus according to claim 3, wherein
the setting unit sets the first-developing-unit exposure energy to first energy when the downstream developing unit number is a first number, and
the setting unit sets the first-developing-unit exposure energy to second energy when the downstream developing unit number is a second number.

6. The image forming apparatus according to claim 1, wherein
the one or more developing units comprise a plurality of developing units that form the respective developer images with respective developers of respective colors different from each other,
the plurality of developing units includes a second developing unit operably set to one of the one or more downstream stations, and
the developing unit information includes information related to a color of the developer to be used in the second developing unit.

7. The image forming apparatus according to claim 6, wherein
the setting unit sets the first-developing-unit development voltage to a first voltage when the color of the developer to be used in the second developing unit is a first color, and
the setting unit sets the first-developing-unit development voltage to a second voltage when the color of the developer to be used in the second developing unit is a second color.

8. The image forming apparatus according to claim 6, wherein
the setting unit sets the first-developing-unit exposure energy to first energy when the color of the developer to be used in the second developing unit is a first color, and
the setting unit sets the first-developing-unit exposure energy to second energy when the color of the developer to be used in the second developing unit is a second color.

9. The image forming apparatus according to claim 6, wherein
the one or more primary transfer members comprise a plurality of primary transfer members corresponding to the respective plurality of developing units, and
the voltage application unit further applies a transfer voltage to one, of the plurality of primary transfer members, corresponding to the second developing unit, the transfer voltage being a voltage corresponding to the color of the developer to be used in the second developing unit.

10. The image forming apparatus according to claim 1, wherein the setting unit sets the first-developing-unit development voltage, the first-developing-unit exposure energy, or both when any of the one or more developing units each operably set to the corresponding one of the plurality of stations is changed.

11. The image forming apparatus according to claim 1, wherein the one or more developing units include a basic-color developing unit and an auxiliary-color developing unit, the basic-color developing unit forming the developer image with a basic-color developer, the auxiliary-color developing unit forming the developer image with an auxiliary-color developer.

12. The image forming apparatus according to claim 11, wherein the auxiliary-color developer comprises a white developer.

13. The image forming apparatus according to claim 11, wherein the auxiliary-color developer comprises a transparent developer.

14. The image forming apparatus according to claim 11, wherein the auxiliary-color developing unit is operably set to one, of the plurality of stations, positioned most upstream in the direction of the conveyance performed by the image conveying member.

15. The image forming apparatus according to claim 11, wherein the auxiliary-color developing unit is operably set to one, of the plurality of stations, positioned most downstream in the direction of the conveyance performed by the image conveying member.

16. The image forming apparatus according to claim 1, wherein the first developing unit is settable to any of the plurality of stations.
